(19) United States
(12) Patent Application Publication
(10) Pub. No.: US 2024/0214172 A1
(43) Pub. Date: Jun. 27, 2024

(54) BEAM CONFIGURATION ACTIVATION AND DEACTIVATION UNDER MULTIPLE TRANSMIT RECEIVE POINT (TRP) OPERATION

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/567,721

(22) PCT Filed: Aug. 6, 2021
(86) PCT No.: PCT/CN2021/111143

§ 371 Date: Dec. 6, 2023

(51) Int. Cl. H04L 5/00

(52) U.S. Cl. CPC H04L 5/0092; H04L 5/0035

(57) ABSTRACT

This disclosure provides systems, methods and apparatus, including computer programs encoded on computer storage media, for TCI state activation and deactivation under multiple transmit receive point (TRP) operation. In some aspects, a number of activated transmission configuration indicator (TCI) states, and TCI state types, can be indicated using a single codepoint. In some implementations, codepoints may include multiple TCI states. Each TCI state identifier in the codepoint may correspond to a TCI state type, such as uplink, downlink, or both. In some implementations, the base station (BS) may configure two separate TCI state lists, one for downlink and one for uplink. Each codepoint may include an indication of one of the two configured lists with which the TCI state identifier is associated. In some implementations, the BS may configure two bitmaps, where a first bitmap corresponds to downlink TCI states, and a second bitmap corresponds to uplink TCI states.

### CROSS REFERENCE

The present application is a 371 national stage filing of International PCT Application No. PCT/CN2021/111143 by YUAN et al. entitled “BEAM CONFIGURATION ACTIVATION AND DEACTIVATION UNDER MULTIPLE TRANSMIT RECEIVE POINT (TRP) OPERATION,” filed Aug. 6, 2023, which is assigned to the assignee hereof, and which is expressly incorporated by reference in its entirety herein.

### TECHNICAL FIELD

This disclosure relates to wireless communications, including beam configuration activation and deactivation under multiple transmit receive point operation.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE). A UE may communicate with a base station using one or more beam configurations.

### SUMMARY

The systems, methods and devices of this disclosure each have several innovative aspects, no single one of which is solely responsible for the desirable attributes disclosed herein.

One innovating aspect of the subject matter described in this disclosure can be implemented in a method for wireless communications at a user equipment (UE). The method may include receiving, from a network entity, control signaling identifying a set of transmission configuration indicator (TCI) states, each TCI state of the set of TCI states associated with a TCI state type, receiving, from the network entity, a media access control (MAC) control element (CE) message including a set of codepoints, each codepoint of the set of codepoints activating one or more TCI states of the set of TCI states and indicating the TCI state type for the one or more TCI states, receiving, from the network entity, a DCI message including a grant of resources for communicating with at least a first transmission reception point (TRP) associated with the network entity and an indication of at least one TCI state of the one or more TCI states, and communicating with the at least the first TRP according to the at least one TCI state.

Another innovative aspect of the subject matter described in this disclosure can be implemented in an apparatus for wireless communications at a UE. The apparatus may include a processor, memory coupled with the processor, and instructions stored in the memory. The instructions may be executable by the processor to cause the apparatus to receive, from a network entity, control signaling identifying a set of TCI states, each TCI state of the set of TCI states associated with a TCI state type, receive, from the network entity, a MAC CE message including a set of codepoints, each codepoint of the set of codepoints activating one or more TCI states of the set of TCI states and indicating the TCI state type for the one or more TCI states, receive, from the network entity, a DCI message including a grant of resources for communicating with at least a first TRP associated with the network entity and an indication of at least one TCI state of the one or more TCI states, and communicate with the at least the first TRP according to the at least one TCI state.

Another innovative aspect of the subject matter described in this disclosure can be implemented in an apparatus for wireless communications at a UE. The apparatus may include means for receiving, from a network entity, control signaling identifying a set of TCI states, each TCI state of the set of TCI states associated with a TCI state type, means for receiving, from the network entity, a MAC CE message including a set of codepoints, each codepoint of the set of codepoints activating one or more TCI states of the set of TCI states and indicating the TCI state type for the one or more TCI states, means for receiving, from the network entity, a DCI message including a grant of resources for communicating with at least a first TRP associated with the network entity and an indication of at least one TCI state of the one or more TCI states, and means for communicating with the at least the first TRP according to the at least one TCI state.

Another innovative aspect of the subject matter described in this disclosure can be implemented in a non-transitory computer-readable medium storing code for wireless communications at a UE. The code may include instructions executable by a processor to receive, from a network entity, control signaling identifying a set of TCI states, each TCI state of the set of TCI states associated with a TCI state type, receive, from the network entity, a MAC CE message including a set of codepoints, each codepoint of the set of codepoints activating one or more TCI states of the set of TCI states and indicating the TCI state type for the one or more TCI states, receive, from the network entity, a DCI message including a grant of resources for communicating with at least a first TRP associated with the network entity and an indication of at least one TCI state of the one or more TCI states, and communicate with the at least the first TRP according to the at least one TCI state.

In some examples of the method, apparatuses, and non-transitory computer-readable medium described herein, receiving the MAC-CE may include operations, features, means, or instructions for receiving the set of codepoints in the MAC-CE, each codepoint including a first bit indicating whether the codepoint indicates a single TCI state or a pair of TCI states.

In some examples of the method, apparatuses, and non-transitory computer-readable medium described herein, receiving the control signaling identifying the set of TCI states may include operations, features, means, or instructions for receiving the control signaling including an indication of a first subset of the set of TCI states associated with the TCI state type including uplink, and an indication of a second subset of the set of TCI states associated with the TCI state type including downlink.

In some examples of the method, apparatuses, and non-transitory computer-readable medium described herein, receiving the MAC-CE may include operations, features, means, or instructions for receiving, in the MAC-CE, a first bitmap associated with the first subset of the set of TCI states and receiving, in the MAC-CE, a second bitmap associated with the second subset of the set of TCI states.

Another innovative aspect of the subject matter described in this disclosure can be implemented in a method for wireless communications. The method may include transmitting, to a UE, control signaling identifying a set of TCI states, each TCI state of the set of TCI states associated with a TCI state type, the TCI state type, transmitting, to the UE, a MAC CE message including a set of codepoints, each codepoint of the set of codepoints activating one or more TCI states of the set of TCI states and indicating the TCI state type for the one or more TCI states, and transmitting, to the UE, a downlink control information message including a grant of resources for communicating with at least a first transmission reception point associated with the network entity and an indication of at least one TCI state of the one or more TCI states.

Another innovative aspect of the subject matter described in this disclosure can be implemented in an apparatus for wireless communications. The apparatus may include a processor, memory coupled with the processor, and instructions stored in the memory. The instructions may be executable by the processor to cause the apparatus to transmit, to a UE, control signaling identifying a set of TCI states, each TCI state of the set of TCI states associated with a TCI state type, the TCI state type, transmit, to the UE, a MAC CE message including a set of codepoints, each codepoint of the set of codepoints activating one or more TCI states of the set of TCI states and indicating the TCI state type for the one or more TCI states, and transmit, to the UE, a downlink control information message including a grant of resources for communicating with at least a first transmission reception point associated with the network entity and an indication of at least one TCI state of the one or more TCI states.

Another innovative aspect of the subject matter described in this disclosure can be implemented in an apparatus for wireless communications. The apparatus may include means for transmitting, to a UE, control signaling identifying a set of TCI states, each TCI state of the set of TCI states associated with a TCI state type, the TCI state type, means for transmitting, to the UE, a MAC CE message including a set of codepoints, each codepoint of the set of codepoints activating one or more TCI states of the set of TCI states and indicating the TCI state type for the one or more TCI states, and means for transmitting, to the UE, a downlink control information message including a grant of resources for communicating with at least a first transmission reception point associated with the network entity and an indication of at least one TCI state of the one or more TCI states.

Another innovative aspect of the subject matter described in this disclosure can be implemented in a non-transitory computer-readable medium storing code for wireless communications. The code may include instructions executable by a processor to transmit, to a UE, control signaling identifying a set of TCI states, each TCI state of the set of TCI states associated with a TCI state type, the TCI state type, transmit, to the UE, a MAC CE message including a set of codepoints, each codepoint of the set of codepoints activating one or more TCI states of the set of TCI states and indicating the TCI state type for the one or more TCI states, and transmit, to the UE, a downlink control information message including a grant of resources for communicating with at least a first transmission reception point associated with the network entity and an indication of at least one TCI state of the one or more TCI states.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates an example of a wireless communications system that supports beam configuration activation and deactivation under multiple transmit receive point (TRP) operation.

FIG. 2 illustrates an example of a signaling diagram that supports beam configuration activation and deactivation under multiple transmit receive point operation.

FIG. 3 illustrates an example of a media access control-control element (MAC-CE) that supports beam configuration activation and deactivation under multiple transmit receive point operation.

FIG. 4 illustrates an example of a MAC-CE that supports beam configuration activation and deactivation under multiple transmit receive point operation.

FIG. 5 illustrates an example of a MAC-CE that supports beam configuration activation and deactivation under multiple transmit receive point operation.

FIG. 6 illustrates an example of a process flow that supports beam configuration activation and deactivation under multiple transmit receive point operation.

FIG. 7 shows a diagram of an example system including a device that supports beam configuration activation and deactivation under multiple transmit receive point operation.

FIG. 8 shows a diagram of an example system including a device that supports beam configuration activation and deactivation under multiple transmit receive point operation.

FIGS. 9 and 10 show example flowcharts illustrating methods that support beam configuration activation and deactivation under multiple transmit receive point operation.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Implementations described herein provide techniques for indicating a number of activated TCI states, and types of TCI states, using a single codepoint. In some implementations, codepoints may include one or two TCI states, and each respective TCI state identifier in the codepoint may correspond to a TCI state type, such as uplink, downlink, or both. For example, an implementation provides for one TCI state or multiple TCI states mapped to a single TCI codepoint, where the single TCI codepoint also indicates respective TCI state types for the activated TCI states. In some implementations, the base station (BS) may configure two separate TCI state lists, one for downlink TCI states and one for uplink TCI states. Each codepoint may include one or multiple TCI state identifiers, and an indication of one of the two configured lists with which the TCI state identifier is associated. In some implementations, the BS may configure two bitmaps, where a first bitmap corresponds to downlink TCI states, and a second bitmap corresponds to uplink TCI states. Each codepoint in a MAC-CE that activates one or more TCI states may include one bit from the first bitmap, such as indicating an UL TCI state in a pair of TCI states, and one bit from the second bitmap, such as indicating a DL TCI state in a pair of TCI states. In some implementations, a last remaining bit, such as if an odd number of bits are activated in the two bitmaps, may indicate a single TCI state, such as uplink or downlink.

Particular implementations of the subject matter described in this disclosure can be implemented to realize one or more of the following potential advantages. For example, a single TCI codepoint may be mapped with two TCI states and indicated with TCI state types. By indicating the TCI state types corresponding to the mapped TCI states in a single codepoint, signaling overhead may be reduced. Further, described techniques may support increased flexibility for a UE, because the base station may be able to activate more TCI states of different types (such as, joint or separate TCI states, and unified TCI states) without a corresponding increase in signaling. This may result in more efficient use of spatial resources, as well as decreased collisions and interference, without introducing signaling delays and increased system latency. Thus, described techniques may result increased reliability of communications and improved user experience. The single TCI codepoint mapped with one or two TCI states of different TCI state types may be applied in both single DCI scheduled multiple transmission reception point (M-TRP) transmission, or multiple DCI scheduled M-TRP transmission. Thus, described techniques may result in more efficient use of spatial resources and decreased interference, and may avoid a corresponding increase in signaling delays and system latency. Further, described techniques may support flexible and efficient indications of TCI states supporting M-TRP communications, resulting in more efficient and reliable communications and decreased signaling overhead.

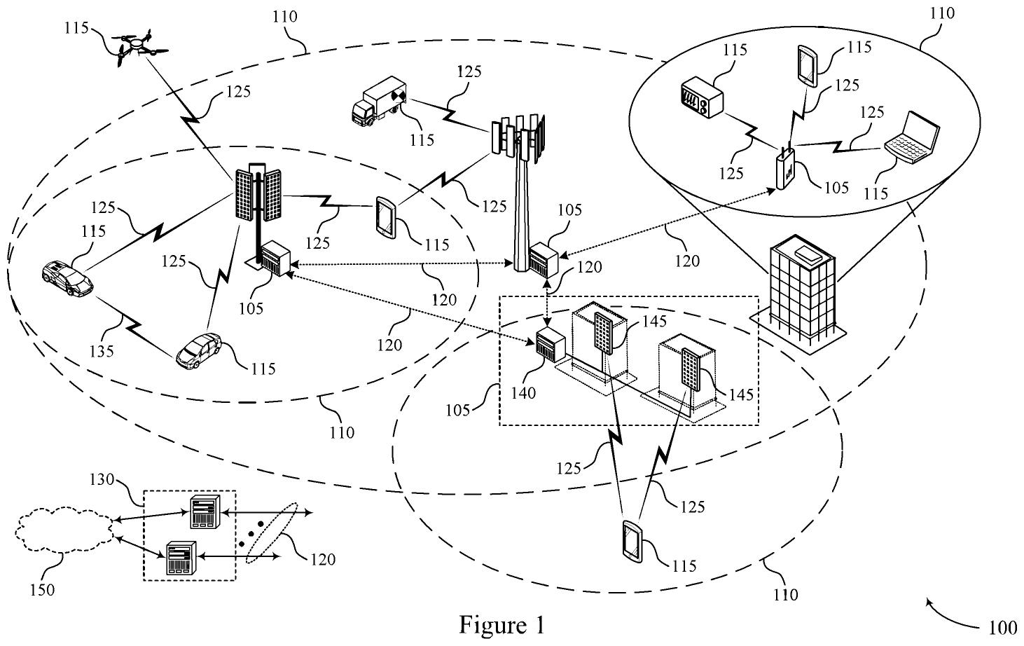

FIG. 1 illustrates an example of a wireless communications system 100 that supports beam configuration activation and deactivation under multiple transmit receive point operation. The wireless communications system 100 may include one or more BSs 105, one or more UEs 115, and a core network 1301. In some implementations, the wireless communications system 100 may be a Long Term Evolution (LTE) network, an LTE-Advanced (LTE-A) network, an LTE-A Pro network, or a New Radio (NR) network. In some implementations, the wireless communications system 100 may support enhanced broadband communications, ultra-reliable (for example, mission critical) communications, low latency communications, communications with low-cost and low-complexity devices, or any combination thereof.

The BSs 105 may be dispersed throughout a geographic area to form the wireless communications system 100 and may be devices in different forms or having different capabilities. The BSs 105 and the UEs 115 may wirelessly communicate via one or more communication links 125. Each BS 105 may provide a coverage area 110 over which the UEs 115 and the BS 105 may establish one or more communication links 125. The coverage area 110 may be an example of a geographic area over which a BS 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the BSs 105, or network equipment (for example, core network nodes, relay devices, integrated access and backhaul (IAB) nodes, or other network equipment), as shown in FIG. 1.

The BSs 105 may communicate with the core network 130, or with one another, or both. For example, the BSs 105 may interface with the core network 130 through one or more backhaul links 120 (for example, via an S1, N2, N3, or another interface). The BSs 105 may communicate with one another over the backhaul links 120 (for example, via an X2, Xn, or another interface) either directly (for example, directly between BSs 105), or indirectly (for example, via core network 130), or both. In some implementations, the backhaul links 120 may be or include one or more wireless links.

One or more of the BSs 105 described herein may include or may be referred to by a person having ordinary skill in the art as a base transceiver station, a radio BS, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other implementations.

The UEs 115 described herein may be able to communicate with various types of devices, such as other UEs 115 that may sometimes act as relays as well as the BSs 105 and the network equipment including macro eNBs or gNBs, small cell eNBs or gNBs, or relay BSs, among other implementations, as shown in FIG. 1.

The UEs 115 and the BSs 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation (CA) or multi-carrier operation. A UE 115 may be configured with multiple downlink component carriers and one or more uplink component carriers according to a CA configuration. CA may be used with both frequency division duplexing (FDD) and time division duplexing (TDD) component carriers.

In some implementations (for example, in a CA configuration), a carrier also may have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (for example, of the same or a different radio access technology).

The communication links 125 shown in the wireless communications system 100 may include uplink transmissions from a UE 115 to a BS 105, or downlink transmissions from a BS 105 to a UE 115. Carriers may carry downlink or uplink communications (for example, in an FDD mode) or may be configured to carry downlink and uplink communications (for example, in a TDD mode).

A carrier may be associated with a particular bandwidth of the radio frequency spectrum, and in some implementations the carrier bandwidth may be referred to as a “system bandwidth” of the carrier or the wireless communications system 100 For example, the carrier bandwidth may be one of a number of determined bandwidths for carriers of a particular radio access technology (for example, 1.4, 3, 5, 10, 15, 20, 40, or 80 megahertz (MHz)). Devices of the wireless communications system 100 (for example, the BSs 105, the UEs 115, or both) may have hardware configurations that support communications over a particular carrier bandwidth or may be configurable to support communications over one of a set of carrier bandwidths. In some implementations, the wireless communications system 100 may include BSs 105 or UEs 115 that support simultaneous communications via carriers associated with multiple carrier bandwidths. In some implementations, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (for example, a duration of one modulation symbol) and one subcarrier, where the symbol period and subcarrier spacing are inversely related. The quantity of bits carried by each resource element may depend on the modulation scheme (for example, the order of the modulation scheme, the coding rate of the modulation scheme, or both) Thus, the more resource elements that a UE 115 receives and the higher the order of the modulation scheme, the higher the data rate may be for the UE 115A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefixA carrier may be divided into one or more BWPs having the same or different numerologies. In some implementations, a UE 115 may be configured with multiple BWPs. In some implementations, a single BWP for a carrier may be active at a given time and communications for the UE 115 may be restricted to one or more active BWPs.

The time intervals for the BSs 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) sizeTime intervals of a communications resource may be organized according to radio frames each having a specified duration (for example, 10 milliseconds (ms)) Each radio frame may be identified by a system frame number (SFN) (for example, ranging from 0 to 1023).

Each frame may include multiple consecutively numbered subframes or slots, and each subframe or slot may have the same duration. In some implementations, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period) In some wireless communications systems 100, a slot may further be divided into multiple mini-slots containing one or more symbols. Excluding the cyclic prefix, each symbol period may contain one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI) In some implementations, the TTI duration (for example, the number of symbol periods in a TTI) may be variable. Additionally, or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

Each BS 105 may provide communication coverage via one or more cells, for example a macro cell, a small cell, a hot spot, or other types of cells, or any combination thereof. The term “cell” may refer to a logical communication entity used for communication with a BS 105 (for example, over a carrier) and may be associated with an identifier for distinguishing neighboring cells (for example, a physical cell identifier (PCID), a virtual cell identifier (VCID), or others). In some implementations, a cell also may refer to a geographic coverage area 110 or a portion of a geographic coverage area 110 (for example, a sector) over which the logical communication entity operates. Such cells may range from smaller areas (for example, a structure, a subset of structure) to larger areas depending on various factors such as the capabilities of the BS 105F. For example, a cell may be or include a building, a subset of a building, or exterior spaces between or overlapping with geographic coverage areas 110, among other implementations.

A macro cell generally covers a relatively large geographic area (for example, several kilometers in radius) and may allow unrestricted access by the UEs 115 with service subscriptions with the network provider supporting the macro cell. A small cell may be associated with a lower-powered BS 105, as compared with a macro cell, and a small cell may operate in the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A BS 105 may support one or multiple cells and also may support communications over the one or more cells using one or multiple component carriers.

In some implementations, a carrier may support multiple cells, and different cells may be configured according to different protocol types (for example, MTC, narrowband IoT (NB-IoT), enhanced mobile broadband (eMBB)) that may provide access for different types of devices.

In some implementations, a BS 105 may be movable and therefore provide communication coverage for a moving geographic coverage area 110. In some implementations, different geographic coverage areas 110 associated with different technologies may overlap, but the different geographic coverage areas 110 may be supported by the same BS 105. In some other implementations, the overlapping geographic coverage areas 110 associated with different technologies may be supported by different BSs 105. The wireless communications system 100 may include, for example, a heterogeneous network in which different types of the BSs 105 provide coverage for various geographic coverage areas 110 using the same or different radio access technologies.

The wireless communications system 100 may support synchronous or asynchronous operation. For synchronous operation, the BSs 105 may have similar frame timings, and transmissions from different BSs 105 may be approximately aligned in time. For asynchronous operation, the BSs 105 may have different frame timings, and transmissions from different BSs 105 may, in some implementations, not be aligned in time. The techniques described herein may be used for either synchronous or asynchronous operations.

Some UEs 115, such as MTC or IoT devices, may be low cost or low complexity devices and may provide for automated communication between machines (for example, via Machine-to-Machine (M2M) communication). M2M communication or MTC may refer to data communication technologies that allow devices to communicate with one another or a BS 105 without human intervention. In some implementations, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (for example, a mode that supports one-way communication via transmission or reception, but not transmission and reception simultaneously). In some implementations, half-duplex communications may be performed at a reduced peak rate. Other power conservation techniques for the UEs 115 include entering a power saving deep sleep mode when not engaging in active communications, operating over a limited bandwidth (for example, according to narrowband communications), or a combination of these techniques. For example, some UEs 115 may be configured for operation using a narrowband protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some implementations, a UE 115 also may be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a BS 105. Other UEs 115 in such a group may be outside the geographic coverage area 110 of a BS 105 or be otherwise unable to receive transmissions from a BS 105. In some implementations, groups of the UEs 115 communicating via D2D communications may utilize a one-to-many (1:M) system in which each UE 115 transmits to every other UE 115 in the group. In some implementations, a BS 105 facilitates the scheduling of resources for D2D communications. In some other implementations, D2D communications are carried out between the UEs 115 without the involvement of a BS 105.

In some implementations, the D2D communication link 135 may be an example of a communication channel, such as a sidelink communication channel, between vehicles (for example, UEs 115). In some implementations, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some implementations, vehicles in a V2X system may communicate with roadside infrastructure, such as roadside units, or with the network via one or more network nodes (for example, BSs 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5 GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the BSs 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a BS 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or BS 105 may be distributed across various network devices (for example, radio heads and ANCs) or consolidated into a single network device (for example, a BS 105). In various implementations, a BS 105, or an access network entity 140, or a core network 130, or some subcomponent thereof, may be referred to as a network entity.

As described herein, a BS 105 may include components that are located at a single physical location or components located at various physical locations. In examples in which the BS 105 includes components that are located at various physical locations, the various components may each perform various functions such that, collectively, the various components achieve functionality that is similar to a BS 105 that is located at a single physical location. As such, a BS 105 described herein may equivalently refer to a standalone BS 105 or a BS 105 including components that are located at various physical locations. In some implementations, such a BS 105 including components that are located at various physical locations may be referred to as or may be associated with a disaggregated radio access network (RAN) architecture, such as an Open RAN (O-RAN) or Virtualized RAN (VRAN) architecture. In some implementations, such components of a BS 105 may include or refer to one or more of a central unit (CU), a distributed unit (DU), or a radio unit (RU).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 also may operate in a super high frequency (SHF) region using frequency bands from 3 GHz to 30 GHz, also known as the centimeter band, or in an extremely high frequency (EHF) region of the spectrum (for example, from 30 GHz to 300 GHz), also known as the millimeter band. In some implementations, the wireless communications system 100 may support millimeter wave (mmW) communications between the UEs 115 and the BSs 105, and EHF antennas of the respective devices may be smaller and more closely spaced than UHF antennas. In some implementations, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the BSs 105 and the UEs 115 may employ carrier sensing for collision detection and avoidance. In some implementations, operations in unlicensed bands may be associated with a CA configuration in conjunction with component carriers operating in a licensed band (for example, LAA). Operations in unlicensed spectrum may include downlink transmissions, uplink transmissions, P2P transmissions, or D2D transmissions, among other transmissions.

A BS 105 or a UE 115 may be equipped with multiple antennas, which may be used to employ techniques such as transmit diversity, receive diversity, multiple-input multiple-output (MIMO) communications, or beamforming. The antennas of a BS 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a BS 105 may be located in diverse geographic locations. A BS 105 may have an antenna array with a number of rows and columns of antenna ports that the BS 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The BSs 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which also may be referred to as spatial filtering, directional transmission, or directional reception, is a signal processing technique that may be used at a transmitting device or a receiving device (for example, a BS 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A BS 105 or a UE 115 may use beam sweeping techniques as part of beam forming operations. For example, a BS 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a BS 105 multiple times in different directions. For example, the BS 105 may transmit a signal according to different beamforming weight sets associated with different directions of transmission. Transmissions in different beam directions may be used to identify (for example, by a transmitting device, such as a BS 105, or by a receiving device, such as a UE 115) a beam direction for later transmission or reception by the BS 105.

Some signals, such as data signals associated with a particular receiving device, may be transmitted by a BS 105 in a single beam direction (for example, a direction associated with the receiving device, such as a UE 115). In some implementations, the beam direction associated with transmissions along a determined single beam direction may be associated with a signal that was transmitted in one or more beam directions. For example, a UE 115 may receive one or more of the signals transmitted by the BS 105 in different directions and may report to the BS 105 an indication of the signal that the UE 115 received with a highest signal quality or an otherwise acceptable signal quality.

In some implementations, transmissions by a device (for example, by a BS 105 or a UE 115) may be performed using multiple beam directions, and the device may use a combination of digital precoding or radio frequency beamforming to generate a combined beam for transmission (for example, from a BS 105 to a UE 115). The UE 115 may report feedback that indicates precoding weights for one or more beam directions, and the feedback may correspond to a configured number of beams across a system bandwidth or one or more sub-bands. The BS 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a BS 105, a UE 115 may employ similar techniques for transmitting signals multiple times in different directions (for example, for identifying a beam direction for subsequent transmission or reception by the UE 115) or for transmitting a signal in a single direction (for example, for transmitting data to a receiving device).

A receiving device (for example, a UE 115) may try multiple receive configurations (for example, directional listening) when receiving various signals from the BS 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some implementations, a receiving device may use a single receive configuration to receive along a single beam direction (for example, when receiving a data signal). The single receive configuration may be aligned in a determined beam direction associated with listening according to different receive configuration directions (for example, a beam direction determined to have a highest signal strength, highest signal-to-noise ratio (SNR), or otherwise acceptable signal quality associated with listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer also may use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a BS 105 or a core network 130 supporting radio bearers for user plane data. At the physical layer, transport channels may be mapped to physical channels.

The UEs 115 and the BSs 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example, using a cyclic redundancy check (CRC)), forward error correction (FEC), and retransmission (for example, automatic repeat request (ARQ)) H. ARQ may improve throughput at the MAC layer in poor radio conditions (for example, low signal-to-noise conditions). In some implementations, a device may support same-slot HARQ feedback, where the device may provide HARQ feedback in a specific slot for data received in a previous symbol in the slot. In some other implementations, the device may provide HARQ feedback in a subsequent slot, or according to some other time interval.

In some implementations, such as further enhanced MIMO (FeMIMO), support for joint TCI for downlink and uplink may be associated with other TCI frameworks. The term “TCI” may at least include a TCI state that includes at least one source reference signal to provide a reference, which may be a UE assumption, for determining quasi co-location (QCL), spatial filter, or both. To accommodate implantation of separate beam indications for uplink and downlink, two separate TCI states may be utilized, such as one for downlink and one for uplink. For separate downlink TCI, a source reference signal(s) in M TCIs provide QCL information at least for UE-dedicated reception on physical downlink shared channel (PDSCH) and for UE-dedicated reception on all or a subset of CORESETs in a component carrier. For separate uplink TCI, a source reference signal(s) in N TCIs provide a reference for determining common uplink transmitter spatial filter(s) at least for dynamic-grant/configured-grant based physical uplink shared channel (PUSCH) for all or a subset of dedicated physical uplink control channel (PUCCH) resources in a component carrier. Optionally, the uplink transmitter spatial filter also can apply to all sounding reference signal resources in a resource set(s) configured for antenna switching/codebook-based/non-codebook-based uplink transmissions. Additionally, for unified TCI, where downlink and uplink TCI states are separate, one instance of beam indication using downlink control information (DCI) formats 1_1/1_2 (with and without downlink assignment) may be utilized in a multitude of ways. One TCI field codepoint may represent a pair including a downlink TCI state and an uplink TCI state. Second, one TCI field codepoint represents a downlink TCI state. Additionally, or alternatively, one TCI field codepoint represents an uplink TCI state.

Implementations described herein relate to techniques for indicating a number of activated TCI states and the TCI state types in a single TCI codepoint. The TCI codepoint may include one or multiple TCI state identifiers, and an indication, such as through radio resource control (RRC), of one of the two configured lists with which the TCI state identifier is associated. In some implementations, the BS may configure two bitmaps, where a first bitmap corresponds to downlink TCI states, and a second bitmap corresponds to uplink TCI states. Each codepoint in a MAC-CE that activates one or more TCI states may include one bit from the first bitmap (such as indicating an UL TCI state in a pair of TCI states) and one bit from the second bitmap (such as indicating a DL TCI state in a pair of TCI states). In some implementations, a last remaining bit, such as if an odd number of bits are activated in the two bitmaps, may indicate a single TCI state, such as uplink or downlink. In some other implementations, each codepoint in a MAC-CE that activates one or more TCI states may include one TCI state identifier (ID) from first list (such as a list indicating an UL TCI state in a pair of TCI states) and one TCI state ID from second list (such as a list indicating a DL TCI state in a pair of TCI states).

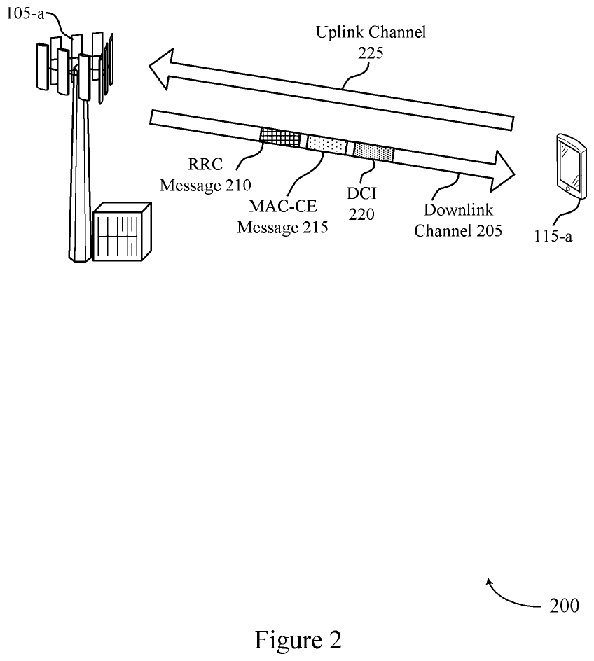

FIG. 2 illustrates an example of a signaling diagram 200 that supports beam configuration activation and deactivation under multiple TRP operation. The signaling diagram 200 may implement or be implemented by one or more aspects of the wireless communications system 100. For example, the signaling diagram 200 may include a UE 115-a and a BS 105-a, which may be examples of the UE 115 and the BS 105 as described with reference to FIG. 1. While examples are discussed herein, any number of devices and device types may be used to accomplish implementations described in the present disclosure. As used herein, the term beam configuration may be referred to as a TCI state, and the term TCI state may be referred to as a beam configuration.

The BS 105-a and the UE 115-a may communicate via a downlink channel 205 and an uplink channel 225. In some implementations, the UE 115-a may receive a configuration of TCI states from the BS 105-a, such as via RRC signaling. The UE 115-a may receive a MAC-CE from the BS 105-a associated with the configuration of TCI states, where the MAC-CE may activate a subset of configured TCI states for the TCI codepoint in DCI. The UE 115-a may receive a DCI (which also may be referred to as a DCI message) with a TCI codepoint selecting TCI states from the activated TCI states, as indicated by the MAC-CE, for use in communications with the BS 105-a.

In some implementations, the BS 105-a and the UE 115-a may utilize one or more types of unified TCI. In some implementations, the BS 105-a and the UE 115-a may utilize joint downlink and uplink common TCI states to indicate a common beam for at least one downlink channel and downlink reference signal, and at least one uplink channel 225 and uplink reference signal. In some other implementations, the BS 105-a and the UE 115-a may utilize a separate downlink common TCI state to indicate a common beam for more than one downlink channel and reference signal. In some other implementations, the BS 105-a and the UE 115-a may utilize a separate common TCJ state to indicate a common beam for more than one uplink channel and reference signal. In yet some other implementations, the BS 105-a and the UE 115-a may utilize a separate, single downlink channel and reference signal TCJ state to indicate a beam for a single downlink channel and reference signal. Similarly, the BS 105-a and the UE 115-a may utilize a separate, single uplink channel and reference signal TCJ state to indicate a beam for a single uplink channel and reference signal. Lastly, the BS 105-a and the UE 115-a may utilize uplink spatial relation information, such as a sounding reference signal resource indicator (SRI), to indicate a beam for a single uplink channel and reference signal. The downlink channels may include a physical downlink control channel (PDCCH), a physical downlink shared channel (PDSCH), or both, and the uplink channels may include a physical uplink control channel (PUCCH), or a physical uplink shared channel (PUSCH), or both. The downlink reference signal may include a CSI-RS, and the uplink reference signal may include a sounding reference signal (SRS).

In some implementations, however, the BS 105-a and the UE 115-a may utilize a joint downlink and uplink common TCJ state to indicate a common beam for at least one downlink channel and reference signal plus at least one uplink channel and reference signal. Additionally, or alternatively, the BS 105-a and the UE 115-a may utilize a separate downlink TCJ state to indicate a common beam for more than one downlink channel and reference signal, a separate uplink common TCJ state to indicate a common beam for more than one uplink channel or reference signal, or both. In implementations utilizing unified TCI, one instance of a beam indication, such as a beam indicated via DCI, may indicate TCJ state types corresponding to the unified TCI. For example, one TCJ field codepoint may represent a pair of TC states, such as one downlink TCJ state and one uplink TCJ state, depending on the TCJ state configuration and activation.

In some implementations, such as those described herein, the TCJ states may be configured by an RRC message 210, which may support UE-specific operations in an multiple TRP arrangement. Additionally, TCJ states from the available TCJ states may be activated for UE-specific physical downlink shared channels (PDSCH), such as via a MAC-CE message 215, for single DCI (sDCI) based multiple TRP operations.

Alternatively, TCI states from the available TCI states may be activated for multiple DCI (mDCI) based multiple TRP operations. That is, a MAC-CE may include a set of codepoints corresponding to the activated TCI states. The MAC-CE may include TCI state identifiers (IDs) for activated TCI states. Additionally, a single TCI codepoint may be mapped to two TCI states in both sDCI and mDCI. In some implementations, both in sDCI and mDCI scenarios, such TCI codepoints in a MAC-CE may not indicate the different TCI state types corresponding to two TCI states indicated in the MAC-CE.

In some wireless communications systems, such as 5G or NR, different types of TCI states may be used to improve channel utilization between wireless devices. For example, a wireless communications system may support joint TCI states for both downlink and uplink signaling using a unified TCI framework. In some systems, wireless communications systems may support a single TCI codepoint that is mapped to multiple TCI states, such as one downlink TCI state and one uplink TCI state. However, such techniques may not clearly indicate the TCI state type of a pair of TCI states, such as joint downlink and uplink TCI states, separate uplink or downlink TCI states, common uplink or downlink TCI states. Alternatively, some wireless communications systems may support TCI activation, such as for mDCI scenarios associated with multi-transmission/reception point (TRP) operations. Such techniques may only support one TCI codepoint that is mapped to a single TCI state. Thus, a method for indicating both multiple TCI states and TCI state types for each activated TCI state may be beneficial. However, using multiple codepoints to indicate each individual state may result in inefficient signaling overhead.

In some other implementations, however, such as those described herein, the UE 115 may receive a TCI codepoint mapped to one or two TCI states, which may include information regarding respective TCI state types. That is, the BS 105-a and the UE 115-a may support activation and deactivation of unified TCI states under multiple TRP operations, where the UE 115-a may receive an indication, via the MAC-CE message 215, a transmit and receive point (TRP) index, such as core resource set (CORESET) pool index, if mDCI based multiple TRP is enabled. Otherwise, in some implementations, a field corresponding to the pool index is reserved. In some other implementations, the UE 115 may receive the MAC-CE message 215 indicating a TCI codepoint that may be mapped with one or two TCI states. The TCI codepoint may indicate separate TCI state activation and deactivation, such as a downlink only TCI codepoint, an uplink only TCI codepoint, or a downlink and uplink TCI codepoint. That is, two or more joint TCI states may be indicated in a single TCI codepoint.

For example, the BS 105-a may configure available TCI states via control signaling, which may identify TCI states corresponding to TCI state types, such as uplink, downlink, or both. For example, the base station 105-a may configure available TCI states via the RRC message 210 for sDCI multiple TRP operations. The UE 115-a may receive the RRC message 210 indicating the set of TCI states. The BS 105-a may transmit the MAC-CE message 215 including a set of codepoints to the UE 115-a, where each of the set of codepoints may activate one or more configured TCI states. That is, the MAC-CE message 215 may include a set of TCI state codepoints, which activate one or more TCI states. In some implementations, the MAC-CE message 215 may indicate separate TCI state activation or joint TCI state activation, or the like. The BS 105 may transmit a DCI message 220 to the UE 115-a indicating which TCI state codepoints to utilize. In some implementations, such as a joint TCI state activation, a single TCI codepoint may indicate two TCI states, such as uplink and downlink, and their corresponding TCI state types. The DCI message 220 may indicate one or more of the activated TCI states for use in communications with the BS 105-a. The UE 115-a may utilize the indicated TCI states and TCI state types to perform communications with the BS 105-a over the uplink channel 225 and the downlink channel 205.

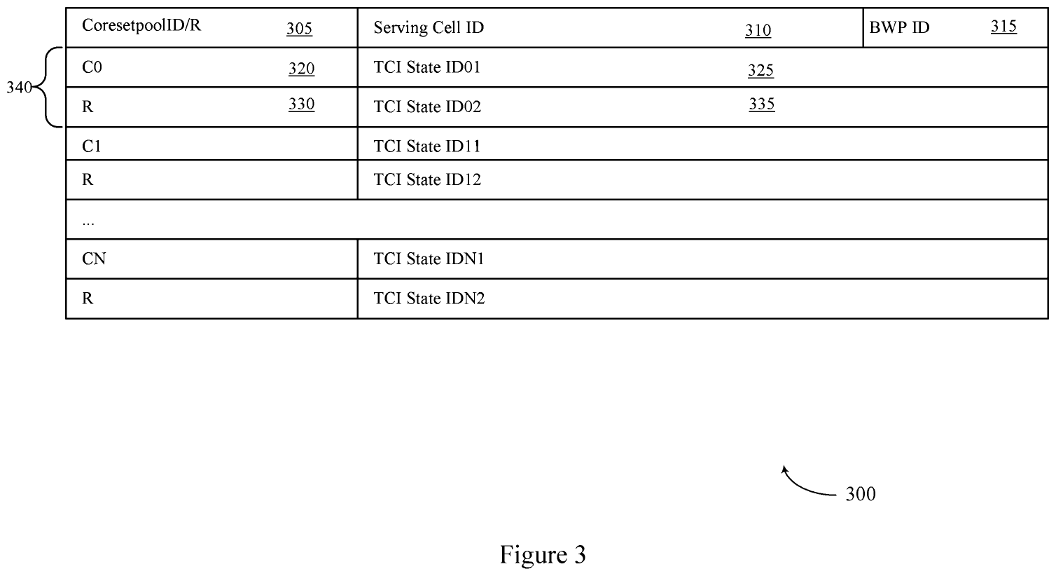

In some implementations, the TCI codepoint may include one or multiple TCI state identifiers, and an indication, such as through RRC, of one of the two configured lists with which the TCI state identifier is associated. In some implementations, the BS may configure two bitmaps, where a first bitmap corresponds to downlink TCI states, and a second bitmap corresponds to uplink TCI states. Each codepoint in a MAC-CE that activates one or more TCI states may include one bit from the first bitmap, such as indicating an UL TCI state in a pair of TCI states, and one bit from the second bitmap, such as indicating a DL TCI state in a pair of TCI states. In some implementations, a last remaining bit, such as if an odd number of bits are activated in the two bitmaps, may indicate a single TCI state, such as uplink or downlink. The utilization of a single TCI list or two TCI lists, as well as two bitmaps, are discussed in more detail in FIGS. 3-6.

FIG. 3 illustrates an example of a media access control-control element (MAC-CE) 300 that supports beam configuration activation and deactivation under multiple TRP (M-TRP) operation. The MAC-CE 300 may implement or be implemented by one or more aspects of the wireless communications system 100 and the signaling diagram 200. For example, the MAC-CE 300 may be utilized by a BS and a UE, which may be examples of a device as described with reference to FIGS. 1 and 2.

In some implementations, the BS may transmit the MAC-CE 300 to the UE. The MAC-CE may include a single list of configured TCI states, where TCI states of different TCI state types have different TCI IDs in the list. Each TCI state in the MAC-CE 300 may be a downlink TCI state, an uplink TCI state, or joint TCI state. The list of TCI states may be configured by the BS via RRC signaling. The MAC-CE may include a field 305, indicating a CORESET pool ID, a field 310 indicating a serving cell ID, and a field 315 indicating a BWP ID. In some implementations, the field 305 may indicate a CORESET pool ID if mDCI based M-TRP operations are enabled and if different CORESET pool indices are configured. In some implementations, the field 305 may be a reserved field if sDCI based M-TRP operations are enabled, and if no CORESET pool index is configured, or if a single CORESET pool index is configured.

The MAC-CE 300 include a set of codepoints, where each codepoint may include a first bit indicating whether the codepoint indicates a single TCI state or a pair of TCI states. Each codepoint may include a set of bits (such as one octet or two octets). For example, field 320 may include a first bit (C0, C1, up to CN). The bit in a field 320 may indicate whether an octet containing a second TCI state of a pair of TCI states is present in the TCI codepoint. If the field 320 is set to 1, then the second TCI state may be present in the TCI codepoint. In such examples, a codepoint 340 may include two octets, including TCI state ID01 and TCI state ID02, where the two TCI states may be of different TCI state types.

The UE may ascertain, identify or determine whether a first codepoint 340 corresponds to a single TCI state or a pair of TCI states. In other words, the first bit in field 320 may indicate whether there are one or two TCI states corresponding to the first codepoint 340. The UE may identify one or two TCI state IDs. For example, if the bit in field 320 is set to 0, then the octet including the reserved field 330 and the field 335 (such as for a second TCI state ID) may not be present. However, if the bit in field 320 is set to 1, then a second TCI state ID may be present in field 335. Each TCI ID may be up to 7 bits. For instance, if the bit in field 320 is set to 1, then a first TCI state ID01, which may be represented by 7 bits, may be present in field 325. Field 330 may be reserved, and field 335 may include a second TCI state ID02, which may be represented by 7 bits. Thus, the two octets of codepoint 340 may indicate a pair of TCI state IDs.

The TCI state types may be identified via the TCI IDs. That is, each unique TCI state ID may indicate parameters for the TCI state as well as the TCI state type for the TCI state (such as, uplink, downlink, or joint). Thus, by receiving and decoding the TCI state IDs, the UE may ascertain, identify or determine the type for each TCI state.

In some implementations, if the first bit in field 320 is equal to 0, the UE may ascertain, identify or determine that the first codepoint 340 includes a single TCI state identifier. The UE may utilize a TCI state ID01 in field 325 and the corresponding TCI state type for communications with the BS (such as transmitting or receiving). The first codepoint 340 may thus include a single octet indicating a single TCI state ID and TCI state type. In some implementations, the UE may map the TCI state ID01 (or the bitstream that defines the TCI state ID01) to the set of TCI states configured via the RRC signaling. In such implementations, each of the TCI states configured via the RRC signaling may be associated with a TCI state ID. The TCI state IDs may be configured in the RRC signaling, in previous signaling, or may be preconfigured. Thus, the TCI state ID in the MAC-CE 300 (such as the TCI state ID01) may match one of the TCI state IDs in the set of TCI states. The UE may map the TCI ID01 to the corresponding TCI ID01 in the set of TCI states, and thus identify which TCI state or TCI states of the set of TCI states is indicated by the codepoint 340.

Having transmitted the MAC-CE 300 to the UE, a single TRP, such as the BS, may transmit a DCI message granting resources for communicating with the TRP. That is, the UE may be instructed, by the single TRP, which activated TCI states to utilize from the active TCI states indicated in the MAC-CE 300. In some implementations, the DCI (such as an sDCI or an mDCI) may instruct the UE to communicate with multiple TRPs using one or more of the active TCI states indicated in the MAC-CE.

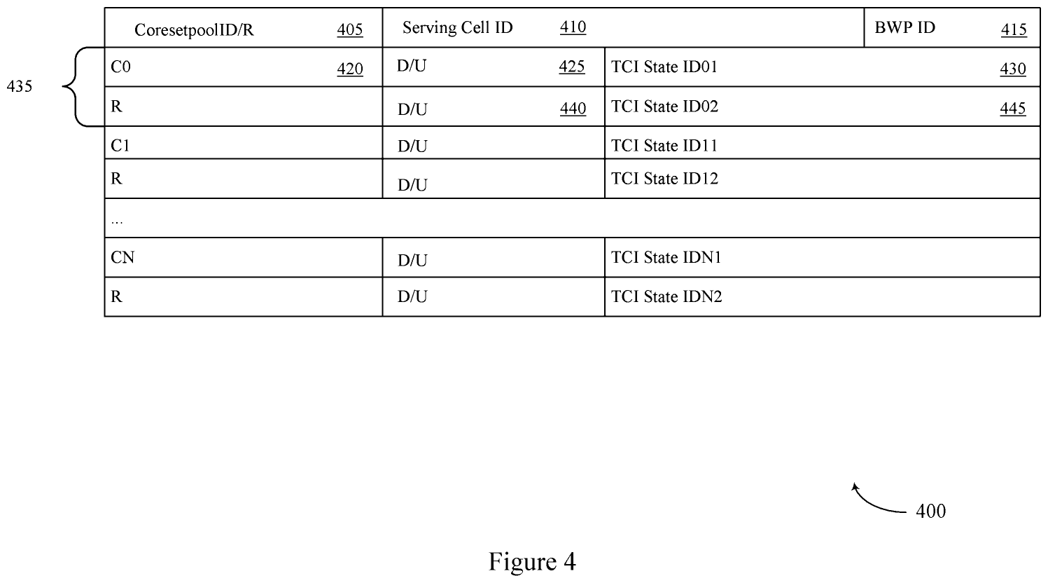

FIG. 4 illustrates an example of a MAC-CE 400 that supports beam configuration activation and deactivation under multiple TRP operation. The MAC-CE 400 may implement or be implemented by one or more aspects of the wireless communications system 100 and the signaling diagram 200. For example, the combined MAC-CE 400 may be utilized by TRP, such as a BS, and a UE, which may be examples of a base station 105 and a UE 115 as described with reference to FIGS. 1 and 2. In some implementations, the MAC-CE 400 may utilize one or more signaling techniques as described with reference to FIG. 3.

In some implementations, the TRP may configure separate TCI state lists, for example, via an RRC message. The UE may receive the RRC message indicating a set of lists corresponding to configured TCI states. In some implementations, one list may contain uplink TCI states, and a second list may contain downlink TCI states. In other words, the TRP may configure two subsets of TCI states, where a first subset corresponds to uplink TCI state types and a second subset corresponds to downlink TCI state types. The TRP may transmit the MAC-CE 400 to the UE indicating activated TCI states and TCI state types. For example, each codepoint in the MAC-CE 400 may indicate one or two TCI states. Each TCI state ID in each list may be defined by up to 6 bits, and an additional bit (such as in each octet) may indicate one of the two lists to which the TCI state ID corresponds.

Similar to the MAC-CE 300 described in FIG. 3, the MAC-CE 400 may include a set of fields, such as a field 405 indicating a CORESET pool ID, a field 410 indicating a serving cell ID, and a field 415 indicating a BWP ID. In some implementations, a bit (such as a first bit of a first octet) in field 420 may indicate whether a TCI state corresponds to a single TCI state or a pair of TCI states. For example, a field 420 may include a first bit (C0, C1, up to CN). The bit in a field 420 may indicate whether a second octet including a second TCI state of a pair of TCI states is present in the MAC-CE 400. If the field 420 is set to 1, then the second TCI state ID (such as a second octet including fields 450, 440, and 445) may be present. In such examples, a codepoint 340 may include two octets, including TCI state ID01 and TCI state ID02. If the field 420 is set to 0, then the second TCI state may not be present. Thus, the UE may ascertain, identify or determine, from the codepoint 435, whether a single TCI state or a joint TCI state is indicated (such as by the first bit in field 420).

Each codepoint 435 also may indicate a type for each indicated TCI state. A bit associated with each TCI state ID (such as in each present octet) may indicate a list with which the TCI state ID is associated. In implementations where the field 420 is set to 0, the UE may ascertain, identify or determine whether the single TCI state corresponds to an uplink TCI state type or a downlink TCI state type associated with a list ID indicated in a field 425. The field 425 may explicitly indicate which list the TCI state type belongs to, such as the uplink TCI state types or the downlink TCI state types. In some implementations, the field 420 in the codepoint 435 may indicate a pair of TCI states. That is, the codepoint 435 may identify a first TCI state and a corresponding first TCI state type, and a second TCI state and a corresponding second TCI state type.

In some implementations, the UE may utilize the list ID in the field 425 to ascertain, identify or determine whether the TCI state corresponds to an uplink TCI state type or a downlink TCI state type. The UE may determine the TCI State ID01 in the field 430. In some implementations, the UE may map the TCI state ID01 (or the bitstream that defines the TCI state ID01) to the set of TCI states configured via the RRC signaling. In such implementations, each of the TCI states configured via the RRC signaling may be associated with a TCI state ID. The TCI state IDs may be configured in the RRC signaling, in previous signaling, or may be preconfigured. Thus, the TCI state ID in the MAC-CE 400 (such as the TCI state ID01) may match, map to, or otherwise correspond to one of the TCI state IDs in the set of TCI states. The UE may map the TCI ID01 to the corresponding TCI ID01 in the set of TCI states, and thus ascertain, identify or determine which TCI state or TCI states of the set of TCI states is indicated by the codepoint 435. Accordingly, because the first bit in the field 420 indicates a pair of TCI states, the UE may utilize a second list ID in a field 440 to determine the TCI state type corresponding to the second TCI state ID, such as uplink or downlink. The UE may map the TCI state ID02 to the set of TCI states.

In some other implementations, if there are a pair of DL and UL TCI states activated in a TCI codepoint by the MAC-CE, the first octet and the second octet for the TCI codepoint may be mapped in a default order of TCI types. For example, when the field 420 for the TCI codepoint 435 is set to 1, the first octet and the second octet for the TCI codepoint 435 may be mapped to DL TCI state and UL TCI state, respectively. In such implementations, the information in the MAC-CE 400 (such as the field 425 and the field 440 or the information therein) may be reduced, which may thereby result in saving overhead resources.

In some implementations, the TCI IDs in the MAC-CE 400 may be up to 6 bits, where a list ID in the field 425 may be indicated together with a TCI ID in the field 430. In other words, the list ID in the field 425 and the second list ID in the field 440 may indicate which list from the MAC-CE 400 the TCI states correspond to. By determining the list ID in the field 425 and the field 440, the UE may determine whether the TCI state types are uplink or downlink. Thus, for a single TCI state ID (such as a TCI state ID01), the codepoint 435 may include a single octet (such as 1 bit in field 420 indicating that a second octet is not present, 1 bit in field 425 indicating which list TCI state ID01 corresponds to, and up to a 6-bit TCI state ID in field 430). For a pair of TCI state IDs (such as TCI state ID01 and TCI state ID02), the codepoint 435 may include two octets (such as 1 bit in field 420 indicating that a second octet is present, 1 bit in field 425 indicating which list TCI state ID01 corresponds to, up to a 6-bit TCI state ID in field 430, a reserved bit in field 450, 1 bit in field 440 indicating which list TCI state ID02 corresponds to, and up to a 6-bit TCI state ID in field 445).

The UE may utilize the MAC-CE 400 to determine N codepoints, where each codepoint may indicate a single TCI state or a joint TCI state. The UE may then receive a DCI selecting one or more of the activated TCI states, and may communicate with one or more TRPs using the selected TCI states.

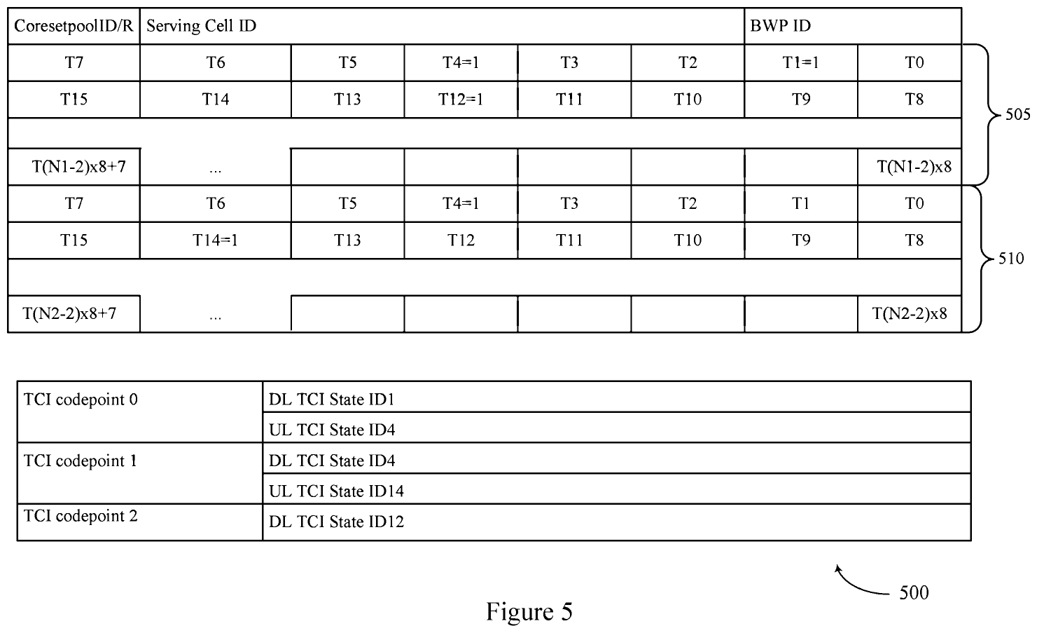

FIG. 5 illustrates an example of a bitmap of a MAC-CE 500 that supports beam configuration activation and deactivation under multiple TRP operation. The MAC-CE 500 may implement or be implemented by one or more aspects of the wireless communications system 100 and the signaling diagram 200. For example, the MAC-CE 500 may be utilized by a TRP, such as a BS, and a UE, which may be examples of a BS 105 and a UE 115 as described with reference to FIGS. 1 and 2. In some implementations, the MAC-CE 500 may indicate TCI states and TCI state types corresponding to joint or separate TCI states, as described with reference to FIGS. 3 and 4.

In some implementations, the base station (such as via a TRP) may configure the UE with two bitmaps corresponding to two lists of TCI states configured via RRC signaling. The first list of TCI states may be a list of downlink TCI states, and the second list of TCI states may be a list of uplink TCI states. Each bit in the two bitmaps may correspond to a TCI state of a corresponding list of TCI states. In some implementations, a first bitmap 505 may indicate a length of the list of downlink TCI states and a second bitmap 510 may indicate a length of the list of uplink TCI states. That is, the first bitmap 505 may correspond to a first subset of TCI states, which may correspond to downlink TCI states, while the second bitmap 510 may correspond to a second subset of TCI states, which may correspond to uplink TCI states.

The base station may transmit MAC-CE 500 to the UE. The MAC-CE 500 may include the bitmap 505 and the bitmap 510. Bits within the first bitmap 505 and the second bitmap 510 may indicate whether a TCI state is activated or deactivated. For example, a bit set to 1 may indicate that the TCI state corresponding to that bit is activated, while a bit set to 0 may indicate that the TCI state corresponding to that bit is deactivated or not activated. The UE may form codepoints by identifying bits for activated TCI states from the first bitmap 505, the second bitmap 510, or both.

The UE may generate codepoints by mapping activated bits to TCI codepoints by order. In some implementations, if a bit in the first bitmap 505 is 0, then the TCI state may be deactivated, and the bit of the bitmap may not be mapped to a code point. For the first bitmap 505, bits T0, T2, T5, T6, T7, T8, T9, T10, T11, T13, T14, and T15 may be set to 0. However, bits T1, T4, and T12 may be set to 1, indicating activated TCI states from the first list of TCI states. Thus, bits T1, T4, and T12 may be mapped to one or more codepoints. Similarly, for the second bitmap 510, bits T0, T1, T2, T3, T5, T6, T7, T8, T9, T10, T11, T12, T13, and T15 may be set to zero, indicated deactivated TCI states, and may not be mapped to a codepoint. However, bits T4 and T14 may be set to 1, indicated activated TCI states which can be mapped, in order to the codepoints.

Each codepoint may include one or two bits, mapped from the activated bits in order. For example, the first activated bit in ascending order for the first bitmap 505 (such as T1) and the first activated bit in ascending order for the second bitmap 505 (such as T4) may be included in TCI codepoint 0. Thus, TCI codepoint 0 may include bits T1 of the first bitmap 505 and T4 of the second bitmap 510. TCI codepoint 0 may therefore indicate (by the association between the bits of each bitmap and corresponding TCI states) DL TCI state ID 1 (from the first list) and UL TCI state ID4 (from the second list). The second activated bit in ascending order for the first bitmap 505 (such as T4) and the second activated bit in ascending order for the second bitmap 505 (such as T14) may be included in the second codepoint. Thus, TCI codepoint 1 may include bits T4 of the first Bitmap 505 and T14 of the second bitmap 510. TCI codepoint 1 may therefore indicate (by the association between the bits of each bitmap and corresponding TCI states) DL TCI state ID4 (from the first list) and UL TCI state ID14 (from the second list). The third activated bit in ascending order for the first bitmap 505 (such as T13) may be included in TCI codepoint 2. However, there may be no additional corresponding activated bit from the second bitmap 510. Thus, TCI codepoint 2 may include a single bit associated with DL TCI state ID12. Thus, by the nature of the ordered mapping of activated TCI states to codepoints, pairs of downlink and uplink TCI states may be activated by a single codepoint (such as TCI codepoint 0 and TCI codepoint 1), or single uplink TCI states or single downlink TCI states (such as DL TCI state ID12) may be activated. In some implementations, techniques described with reference to FIG. 5 may apply for separate TCI state activation.

Upon receiving a DCI (such as an sDCI or an mDCI) indicating one of the activated TCI states, the UE may communicate with one or more TRPs (such as may transmit uplink signaling or receive downlink signaling) using the indicated one or more activated TCI states.

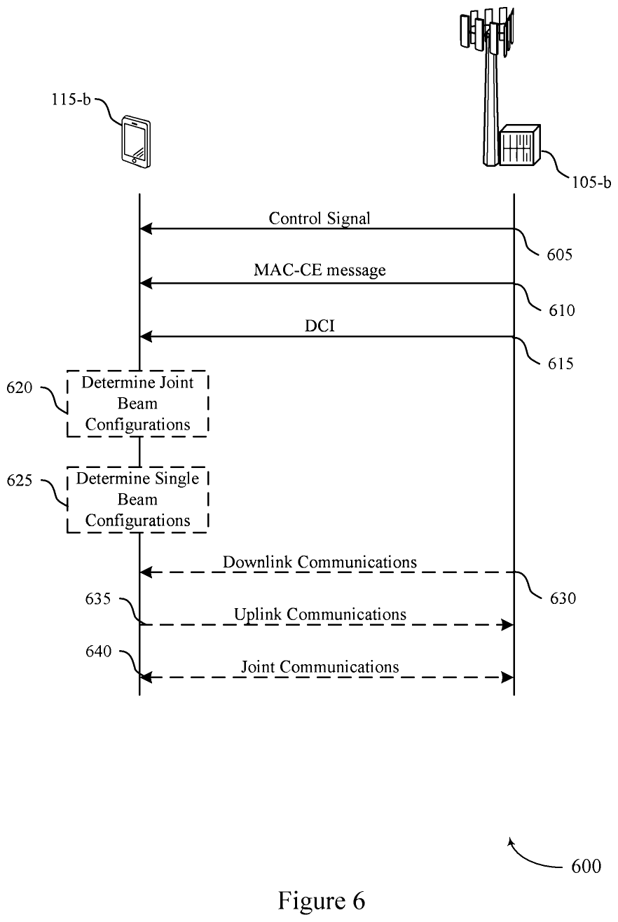

FIG. 6 illustrates an example of a process flow 600 that supports beam configuration activation and deactivation under multiple TRP operation. For example, the process flow 600 may include a UE 115-b and a BS 105-b, which may be examples of UEs 115 and base stations 105 as discussed with reference to FIG. 1. In the following description of the process flow 600, operations between the UE 115-b and the BS 105-b, may occur in a different order or at different times than as shown. Some operations also may be omitted from the process flow 600, and other operations may be added to the process flow 600, such as multiple TRPs in addition to the BS 105-b.

At 605, the BS 105-b may transmit a control signal to the UE 115-b. For example, the BS 105-b may transmit an RRC message to the UE 115-b indicating a set of available beam configurations TCI states, or multiple lists of beam configurations. In some implementations, beam configurations may refer to TCI states. Beam configurations may refer to one or more configurations or settings for transmitting uplink signaling, receiving downlink signaling, or both, such as TCI states. At 610, the BS 105-b may transmit a MAC-CE message to the UE 115-b indicating which TCI states, as indicated by the RRC message at 605, are activated. In some implementations, the MAC-CE message may indicate joint TCI states, single TCI states, or both. In some implementations, the TCI states may be indicated by a single list, including multiple codepoints. A codepoint associated with the multiple TCI states may indicate, via a first bit, whether the codepoint corresponds to a single TCI state and TCI state type or a joint TCI state with corresponding TCI state types, as described above with reference to FIGS. 2-5.

Additionally, or alternatively, as described with reference to FIG. 4, the TCI states may be indicated by multiple lists, where TCI states in a first list may correspond to downlink TCI state types. Similarly, TCI states in a second list may correspond to uplink TCI state types. In such examples, a bit for each TCI state in each codepoint may indicate whether a TCI state is associated with the first list or the second list.

In yet another implementation, the TCI states may be indicated via one or more bitmaps, as discussed herein with reference to FIG. 5. For example, a first bitmap may include bits corresponding to downlink TCI state types and a second bitmap may include bits corresponding to uplink TCI state types. In such examples, pairs of bits from each bitmap, paired together in respective ascending order (with reference to respective bitmaps), may be mapped to codepoints. pairs of mapped bits in a codepoint may indicate joint TCI states, each of the pair of mapped bits associated with a TCI state from one of the two lists (uplink or downlink). Extra bits from one of the two bit maps may be mapped to individual codepoints in ascending order, where the lone bit may indicate a single TCI state corresponding to one of the two lists (uplink and downlink).

At 615, the BS 105-b may transmit a DCI to the UE 115-b, where the DCI may indicate which activated beam configurations (such as TCI states) the UE 115-b may utilize to communicate with the BS 105-b. In some implementations, the UE may determine that a codepoint may correspond to a joint TCI state. For example, optionally, at 620, the UE 115-b may determine joint TCI states associated with the control signal at 605, the MAC-CE message at 610, and the DCI at 615. In such implementations, the UE 115-b may utilize an uplink TCI state and a downlink TCI state to perform uplink and downlink communications with the BS 105-b. In some implementations, the DCI may activate an uplink TCI state for uplink communications, or a downlink TCI state for downlink communications, or both. In some implementations, the DCI message may be an sDCI or an mDCI. In multi-TRP operations, the DCI message may indicate one or more TCI states for communications with multiple TRPs (such as the base station 105-b, one or more additional TRPs, or any combination thereof).

Optionally, at 630, associated with the determination that the TCI state type is a downlink TCI state type, the UE 115-b may perform downlink communications with the BS 105-b. Optionally, at 635, which may be associated with the determination that the TCI state is an uplink TCI state type, the UE 115-b may perform uplink communications with the BS 105-b.

Optionally, at 640, associated with the determination that the TCI state is a joint TCI state, which may correspond to both an uplink TCI state type and a downlink TCI state type, the UE 115-b may perform both uplink and downlink communications with the BS 105-b.

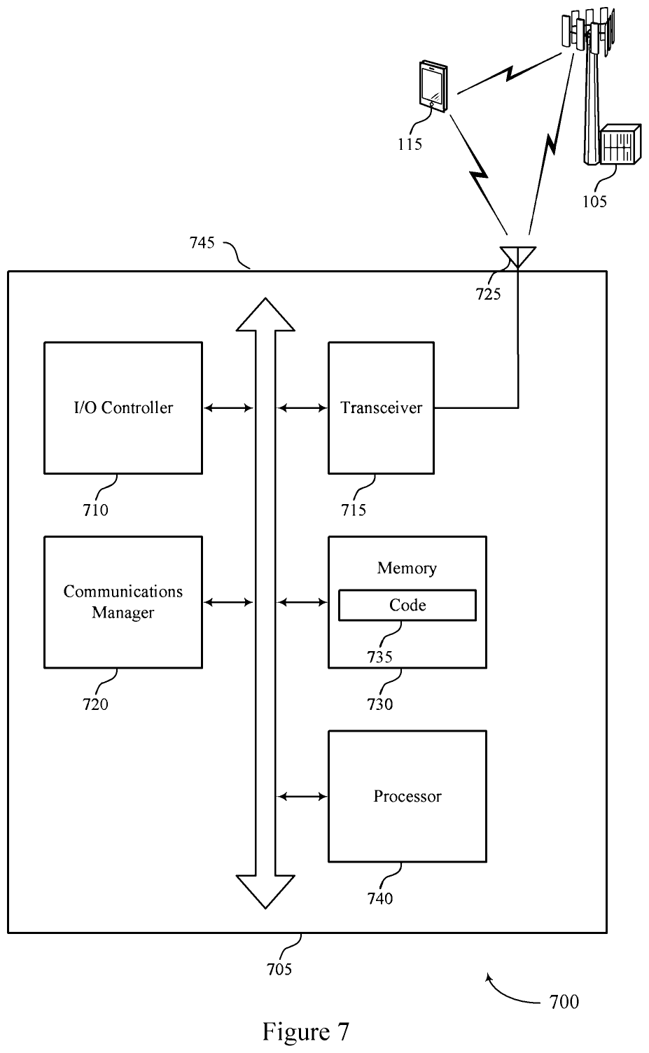

FIG. 7 shows a diagram of an example system 700 including a device 705 that supports beam configuration activation and deactivation under multiple transmit receive point operation. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled, such as operatively, communicatively, functionally, electronically, electrically, via one or more buses, such as a bus 745.

The I/O controller 710 may manage input and output signals for the device 705T. he I/O controller 710 also may manage peripherals not integrated into the device 7051. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some implementations, the I/O controller 710 may be implemented as part of a processor, such as the processor 7401. In some implementations, a user may interact with the device 705 via the I/O controller 710 or via hardware components controlled by the I/O controller 710.

In some implementations, the device 705 may include a single antenna 725. However, in some other implementations, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 also may include a modem to modulate the packets, to provide the modulated packets to one or more antennas 725 for transmission, and to demodulate packets received from the one or more antennas 725

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some implementations, the code 735 may not be directly executable by the processor 740 but may cause a computer, such as when compiled and executed, to perform functions described herein. In some implementations, the memory 730 may contain, among other things, a basic I/O system (BIOS) which may control basic hardware or software operation such as the interaction with peripheral components or devices.

The processor 740 may include an intelligent hardware device, such as a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof) I. In some implementations, the processor 740 may be configured to operate a memory array using a memory controller. In some other implementations, a memory controller may be integrated into the processor 740. The processor 740 may be configured to execute computer-readable instructions stored in a memory, such as the memory 730 to cause the device 705 to perform various functions, such as functions or tasks supporting TCI state activation and deactivation under multiple transmit receive point operation. For example, the device 705 or a component of the device 705 may include a processor 740 and memory 730 coupled to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving, from a network entity, control signaling identifying a set of TCI states, each TCI state of the set of TCI states associated with a TCI state type. The communications manager 720 may be configured as or otherwise support a means for receiving, from the network entity, a MAC control element (CE) message including a set of codepoints, each codepoint of the set of codepoints activating one or more TCI states of the set of TCI states and indicating the TCI state type for the one or more TCI states. The communications manager 720 may be configured as or otherwise support a means for receiving, from the network entity, a DCI message including a grant of resources for communicating with at least a first transmission reception point (TRP) associated with the network entity and an indication of at least one TCI state of the one or more TCI states. The communications manager 720 may be configured as or otherwise support a means for communicating with the at least the first TRP according to the at least one TCI state.

In some implementations, the communications manager 720 may be configured to perform various operations, such as receiving, monitoring, transmitting using or otherwise in cooperation with the transceiver 715, the one or more antennas 725, or any combination thereof. Although the communications manager 720 is illustrated as a separate component, in some implementations, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of TCI state activation and deactivation under multiple transmit receive point operation as described herein, or the processor 740 and the memory 730 may be otherwise configured to perform or support such operations.

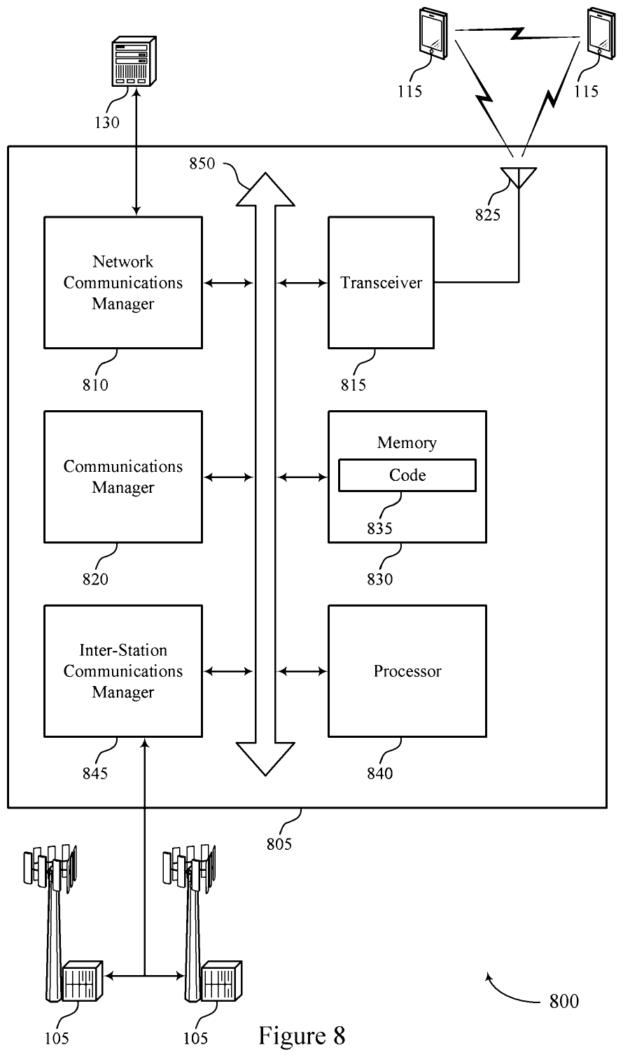

FIG. 8 shows a diagram of an example system 800 including a device 805 that supports TCI state activation and deactivation under multiple transmit receive point operation. The device 805 may include components for bi-directional voice and data communications including components for transmitting and receiving communications, such as a communications manager 820, a network communications manager 810, a transceiver 815, an antenna 825, a memory 830, code 835, a processor 840, and an inter-station communications manager 845. These components may be in electronic communication or otherwise coupled, such as operatively, communicatively, functionally, electronically, electrically via one or more buses, such as a bus 850.

The network communications manager 810 may manage communications with a core network 130, such as via one or more wired backhaul links. For example, the network communications manager 810 may manage the transfer of data communications for client devices, such as one or more UEs 115.

In some implementations, the device 805 may include a single antenna 825. However, in some other implementations the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 also may include a modem to modulate the packets, to provide the modulated packets to one or more antennas 825 for transmission, and to demodulate packets received from the one or more antennas 825.

The memory 830 may include RAM and ROM. The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some implementations, the code 835 may not be directly executable by the processor 840 but may cause a computer, such as when compiled and executed, to perform functions described herein. In some implementations, the memory 830 may contain, among other things, a BIOS which may control basic hardware or software operation such as the interaction with peripheral components or devices.

The processor 840 may include an intelligent hardware device, such as a general-purpose processor, a DSP, a CPU, a microcontroller, an ASIC, an FPGA, a programmable logic device, a discrete gate or transistor logic component, a discrete hardware component, or any combination thereof. In some implementations, the processor 840 may be configured to operate a memory array using a memory controller. In some other implementations, a memory controller may be integrated into the processor 840. The processor 840 may be configured to execute computer-readable instructions stored in a memory, such as the memory 830, to cause the device 805 to perform various functions, such as functions or tasks supporting TCI state activation and deactivation under multiple transmit receive point operation. For example, the device 805 or a component of the device 805 may include a processor 840 and memory 830 coupled to the processor 840, the processor 840 and memory 830 configured to perform various functions described herein.

The inter-station communications manager 845 may manage communications with other base stations 105, and may include a controller or scheduler for controlling communications with UEs 115 in cooperation with other base stations 105. For example, the inter-station communications manager 845 may coordinate scheduling for transmissions to UEs 115 for various interference mitigation techniques such as beamforming or joint transmission. In some implementations, the inter-station communications manager 845 may provide an X2 interface within an LTE/LTE-A wireless communications network technology to provide communication between base stations 105.

The communications manager 820 may support wireless communications in accordance with examples as disclosed herein. For example, the communications manager 820 may be configured as or otherwise support a means for transmitting, to a UE, control signaling identifying a set of TCI states, each TCI state of the set of TCI states associated with a TCI state type, the TCI state type. The communications manager 820 may be configured as or otherwise support a means for transmitting, to the UE, a MAC control element (CE) message including a set of codepoints, each codepoint of the set of codepoints activating one or more TCI states of the set of TCI states and indicating the TCI state type for the one or more TCI states. The communications manager 820 may be configured as or otherwise support a means for transmitting, to the UE, a DCI message including a grant of resources for communicating with at least a first transmission reception point associated with the network entity and an indication of at least one TCI state of the one or more TCI states.

In some implementations, the communications manager 820 may be configured to perform various operations, such as receiving, monitoring, transmitting, using or otherwise in cooperation with the transceiver 815, the one or more antennas 825, or any combination thereof. Although the communications manager 820 is illustrated as a separate component, in some implementations, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of TCI state activation and deactivation under multiple transmit receive point operation as described herein, or the processor 840 and the memory 830 may be otherwise configured to perform or support such operations.

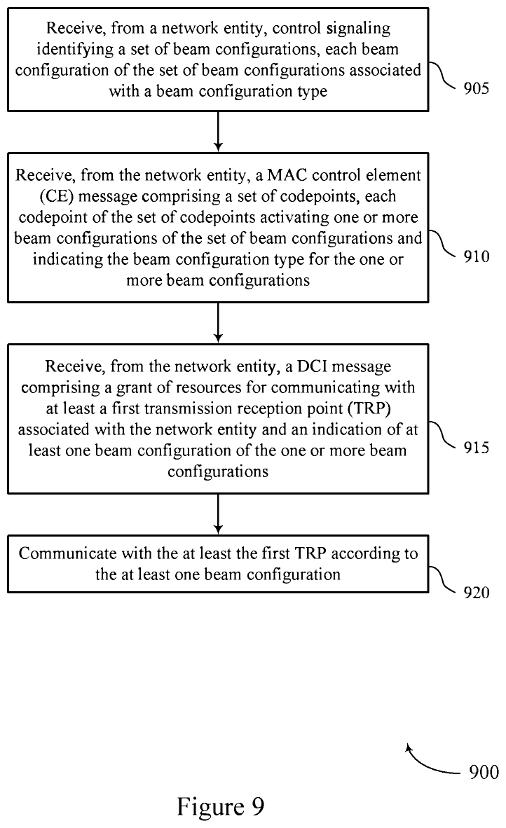

FIG. 9 shows an example flowchart illustrating a method 900 that supports beam configuration activation and deactivation under multiple transmit receive point operation. The operations of the method 900 may be implemented by a UE or its components as described herein. For example, the operations of the method 900 may be performed by a UE 115 as described with reference to FIGS. 1-7. In some implementations, a UE may execute a set of instructions to control the functional elements of the UE to perform the described functions. Additionally, or alternatively, the UE may perform aspects of the described functions using special-purpose hardware.

At 905, the method may include receiving, from a network entity, control signaling identifying a set of TCI states, each TCI state of the set of TCI states associated with a TCI state type. The operations of 905 may be performed in accordance with examples as disclosed herein.

At 910, the method may include receiving, from the network entity, a MAC control element (CE) message including a set of codepoints, each codepoint of the set of codepoints activating one or more TCI states of the set of TCI states and indicating the TCI state type for the one or more TCI states. The operations of 910 may be performed in accordance with examples as disclosed herein.

At 915, the method may include receiving, from the network entity, a DCI message including a grant of resources for communicating with at least a first TRP associated with the network entity and an indication of at least one TCI state of the one or more TCI states. The operations of 915 may be performed in accordance with examples as disclosed herein.

At 920, the method may include communicating with the at least the first TRP according to the at least one TCI state. The operations of 920 may be performed in accordance with examples as disclosed herein.

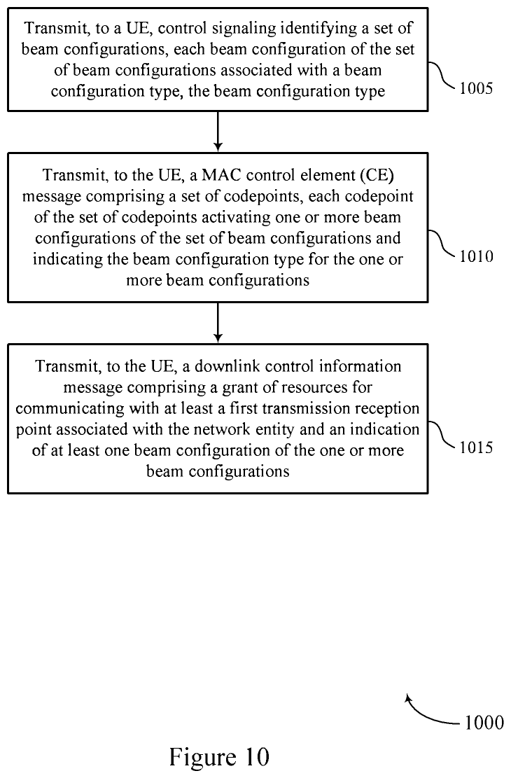

FIG. 10 shows an example flowchart illustrating a method 1000 that supports beam configuration activation and deactivation under multiple transmit receive point operation. The operations of the method 1000 may be implemented by a Network Entity—ALPHA or its components as described herein. For example, the operations of the method 1000 may be performed by a Network Entity—ALPHA as described with reference to FIGS. 1-6 and 8. In some implementations, a Network Entity—ALPHA may execute a set of instructions to control the functional elements of the Network Entity—ALPHA to perform the described functions. Additionally, or alternatively, the Network Entity—ALPHA may perform aspects of the described functions using special-purpose hardware.

At 1005, the method may include transmitting, to a UE, control signaling identifying a set of TCI states, each TCI state of the set of TCI states associated with a TCI state type, the TCI state type. he operations of 1005 may be performed in accordance with examples as disclosed herein.

At 1010, the method may include transmitting, to the UE, a MAC control element (CE) message including a set of codepoints, each codepoint of the set of codepoints activating one or more TCI states of the set of TCI states and indicating the TCI state type for the one or more TCI states. The operations of 1010 may be performed in accordance with examples as disclosed herein.

At 1015, the method may include transmitting, to the UE, a DCI message including a grant of resources for communicating with at least a first transmission reception point associated with the network entity and an indication of at least one TCI state of the one or more TCI states. The operations of 1015 may be performed in accordance with examples as disclosed herein.

The following provides an overview of some aspects of the present disclosure:

Aspect 1: A method for wireless communications at a UE, including: receiving, from a network entity, control signaling identifying a set of TCI states, each TCI state of the set of TCI states associated with a TCI state type; receiving, from the network entity, a MAC CE message including a set of codepoints, each codepoint of the set of codepoints activating one or more TCI states of the set of TCI states and indicating the TCI state type for the one or more TCI states; receiving, from the network entity, a DCI message including a grant of resources for communicating with at least a first TRP associated with the network entity and an indication of at least one TCI state of the one or more TCI states; and communicating with the at least the first TRP according to the at least one TCI state.

Aspect 2: The method of aspect 1, where receiving the MAC-CE includes: receiving the set of codepoints in the MAC-CE, each codepoint including a first bit indicating whether the codepoint indicates a single TCI state or a pair of TCI states.

Aspect 3: The method of any of aspects 1 through 2, where receiving the control signaling identifying the set of TCI states includes: receiving the control signaling including an indication of a first subset of the set of TCI states associated with the TCI state type including uplink, and an indication of a second subset of the set of TCI states associated with the TCI state type including downlink.

Aspect 4: The method of aspect 3, where receiving the MAC-CE includes: receiving, in a first codepoint of the set of codepoints, a first indicator that the codepoint identifies a single TCI state; and receiving, in the first codepoint of the set of codepoints based at least in part on receiving the first bit of each codepoint, a second indicator identifying whether the single TCI state is associated with the first subset of the set of TCI states or the second subset of the set of TCI states.

Aspect 5: The method of any of aspects 3 through 4, where receiving the MAC-CE includes: receiving, in a first codepoint of the set of codepoints, a first indicator that the first codepoint identifies a first TCI state and a second TCI state; receiving, in the first codepoint of the set of codepoints, a second indicator identifying whether the first TCI state is associated with the first subset of the set of TCI states or the second subset of the set of TCI states; and receiving, in the first codepoint of the set of codepoints, a third indicator identifying whether the second TCI state is associated with the first subset of the set of TCI states or the second subset of the set of TCI states.

Aspect 6: The method of any of aspects 3 through 5, where receiving the MAC-CE includes: receiving, in the MAC-CE, a first bitmap associated with the first subset of the set of TCI states; and receiving, in the MAC-CE, a second bitmap associated with the second subset of the set of TCI states.

Aspect 7: The method of aspect 6, further including: receiving a first codepoint of the set of codepoints, the first codepoint corresponding to a bit of the first bitmap and a bit of the second bitmap, and the first codepoint including an indication of a first TCI state of the first subset of the set of TCI states and a second TCI state of the second subset of the set of TCI states.

Aspect 8: The method of any of aspects 6 through 7, further including: receiving a first codepoint of the set of codepoints, the first codepoint corresponding to a single bit from one of the first bitmap or the second bitmap, and the first codepoint including an indication of a single TCI state of a respective one of the first subset of the set of TCI states or the second subset of the set of TCI states.

Aspect 9: The method of any of aspects 1 through 8, where the downlink control information message includes the grant of resources for communicating with a single transmission reception point, the single transmission reception point including the first transmission reception point.

Aspect 10: The method of any of aspects 1 through 9, where the downlink control information message includes the grant of resources for communicating with multiple transmission reception points, the multiple transmission reception points including the first transmission reception point and a second transmission reception point.

Aspect 11: A method for wireless communications, including: transmitting, to a UE, control signaling identifying a set of TCI states, each TCI state of the set of TCI states associated with a TCI state type, the TCI state type; transmitting, to the UE, a MAC CE message including a set of codepoints, each codepoint of the set of codepoints activating one or more TCJ states of the set of TC states and indicating the TCJ state type for the one or more TCJ states; and transmitting, to the UE, a downlink control information message including a grant of resources for communicating with at least a first transmission reception point associated with the network entity and an indication of at least one TCJ state of the one or more TCJ states.

Aspect 12: The method of aspect 11, where transmitting the MAC-CE includes: transmitting the set of codepoints in the MAC-CE, each codepoint including a first indicator that identifies whether the codepoint indicates a single TCJ state or a pair of TC states.

Aspect 13: The method of any of aspects 11 through 12, where transmitting the control signaling identifying the set of TC states includes: transmitting the control signaling including an indication of a first subset of the set of TC states associated with the TCJ state type including uplink, and an indication of a second subset of the set of TCJ states associated with the TCJ state type including downlink.

Aspect 14: The method of aspect 13, where transmitting the MAC-CE includes: transmitting, in a first codepoint of the set of codepoints, a first bit indicator identifying that the codepoint indicates a single TCJ state; and transmitting, in the first codepoint of the set of codepoints based at least in part on transmitting the first bit of each codepoint, a second indicator identifying whether the single TCJ state is associated with the first subset of the set of TC states or the second subset of the set of TC states.

Aspect 15: The method of any of aspects 13 through 14, where transmitting the MAC-CE includes: transmitting, in a first codepoint of the set of codepoints, a first bit indicator that the first codepoint identifies a first TCJ state and a second TCJ state; transmitting, in the first codepoint of the set of codepoints, a second indicator identifying whether the first TCJ state is associated with the first subset of the set of TC states or the second subset of the set of TC states; and transmitting, in the first codepoint of the set of codepoints, a third indicator identifying whether the second TCJ state is associated with the first subset of the set of TC states or the second subset of the set of TC states.

Aspect 16: The method of any of aspects 13 through 15, where transmitting the MAC-CE includes: transmitting, in the MAC-CE, a first bitmap associated with the first subset of the set of TCI states; and transmitting, in the MAC-CE, a second bitmap associated with the second subset of the set of TCI states.

Aspect 17: The method of aspect 16, further including: transmitting a first codepoint of the set of codepoints, the first codepoint corresponding to a bit of the first bitmap and a bit of the second bitmap, and the first codepoint including an indication of a first TCI state of the first subset of the set of TCI states and a second TCI state of the second subset of the set of TCI states.

Aspect 18: The method of any of aspects 16 through 17, further including: transmitting a first codepoint of the set of codepoints, the first codepoint corresponding to a single bit from one of the first bitmap or the second bitmap, and the first codepoint including an indication of a single TCI state of a respective one of the first subset of the set of TCI states or the second subset of the set of TCI states.

Aspect 19: The method of any of aspects 11 through 18, where the downlink control information message includes the grant of resources for communicating with a single transmission reception point, the single transmission reception point including the first transmission reception point.

Aspect 20: The method of any of aspects 11 through 19, where the downlink control information message includes the grant of resources for communicating with multiple transmission reception points, the multiple transmission reception points including the first transmission reception point and a second transmission reception point.

Aspect 21: An apparatus for wireless communications at a UE, including a first interface to: obtain, from a network entity, control signaling identifying a set of TCI states, each TCI state of the set of TCI states associated with a TCI state type; obtain, from the network entity, a MAC CE message including a set of codepoints, each codepoint of the set of codepoints activating one or more TCI states of the set of TCI states and indicating the TCI state type for the one or more TCI states; obtain, from the network entity, a DCI message including a grant of resources for communicating with at least a first TRP associated with the network entity and an indication of at least one TCI state of the one or more TCI states; and the first interface or a second interface configured to output at least one message to the at least the first TRP according to the at least one TCI state.

Aspect 22: The apparatus of aspect 1, where the first interface is further configured to: obtain the set of codepoints in the MAC-CE, each codepoint including a first bit indicating whether the codepoint indicates a single TCI state or a pair of TCI states.

Aspect 23: The method of any of aspects 1 through 2, where the first interface is further configured to: obtain the control signaling including an indication of a first subset of the set of TCI states associated with the TCI state type including uplink, and an indication of a second subset of the set of TCI states associated with the TCI state type including downlink.

Aspect 24: The method of aspect 3, where the first interface is further configured to: obtain, in a first codepoint of the set of codepoints, a first indicator that the codepoint identifies a single TCI state; and receiving, in the first codepoint of the set of codepoints based at least in part on receiving the first bit of each codepoint, a second indicator identifying whether the single TCI state is associated with the first subset of the set of TCI states or the second subset of the set of TCI states.

Aspect 25: The method of any of aspects 3 through 4, where the first interface is further configured to: obtain, in a first codepoint of the set of codepoints, a first indicator that the first codepoint identifies a first TCI state and a second TCI state; receiving, in the first codepoint of the set of codepoints, a second indicator identifying whether the first TCI state is associated with the first subset of the set of TCI states or the second subset of the set of TCI states; and receiving, in the first codepoint of the set of codepoints, a third indicator identifying whether the second TCI state is associated with the first subset of the set of TCI states or the second subset of the set of TCI states.

Aspect 26: The method of any of aspects 3 through 5, where the first interface is further configured to: obtain, in the MAC-CE, a first bitmap associated with the first subset of the set of TCI states; and receiving, in the MAC-CE, a second bitmap associated with the second subset of the set of TCI states.

Aspect 27: The method of aspect 6, where the first interface is further configured to: obtain a first codepoint of the set of codepoints, the first codepoint corresponding to a bit of the first bitmap and a bit of the second bitmap, and the first codepoint including an indication of a first TCI state of the first subset of the set of TCI states and a second TCI state of the second subset of the set of TCI states.

Aspect 28: The method of any of aspects 6 through 7, where the first interface is further configured to: obtain a first codepoint of the set of codepoints, the first codepoint corresponding to a single bit from one of the first bitmap or the second bitmap, and the first codepoint including an indication of a single TCI state of a respective one of the first subset of the set of TCI states or the second subset of the set of TCI states.

Aspect 29: The method of any of aspects 1 through 8, where the downlink control information message includes the grant of resources for communicating with a single transmission reception point, the single transmission reception point including the first transmission reception point.

Aspect 30: The method of any of aspects 1 through 9, where the downlink control information message includes the grant of resources for communicating with multiple transmission reception points, the multiple transmission reception points including the first transmission reception point and a second transmission reception point.

Aspect 31: A method for wireless communications, including a first interface configured to: transmitting, to a UE, control signaling identifying a set of TCI states, each TCI state of the set of TCI states associated with a TCI state type, the TCI state type; transmitting, to the UE, a MAC CE message including a set of codepoints, each codepoint of the set of codepoints activating one or more TCI states of the set of TCI states and indicating the TCI state type for the one or more TCI states; and transmitting, to the UE, a downlink control information message including a grant of resources for communicating with at least a first transmission reception point associated with the network entity and an indication of at least one TCJ state of the one or more TCJ states.

Aspect 32: The method of aspect 11, where the first interface is further configured to: output the set of codepoints in the MAC-CE, each codepoint including a first indicator that identifies whether the codepoint indicates a single TCJ state or a pair of TC states.

Aspect 33: The method of any of aspects 11 through 12, where the first interface is further configured to: output the control signaling including an indication of a first subset of the set of TC states associated with the TCJ state type including uplink, and an indication of a second subset of the set of TC states associated with the TCJ state type including downlink.

Aspect 34: The method of aspect 13, where the first interface is further configured to: output, in a first codepoint of the set of codepoints, a first bit indicator identifying that the codepoint indicates a single TCJ state; and transmitting, in the first codepoint of the set of codepoints based at least in part on transmitting the first bit of each codepoint, a second indicator identifying whether the single TCJ state is associated with the first subset of the set of TC states or the second subset of the set of TC states.

Aspect 35: The method of any of aspects 13 through 14, where the first interface is further configured to: output, in a first codepoint of the set of codepoints, a first bit indicator that the first codepoint identifies a first TCJ state and a second TCJ state; transmitting, in the first codepoint of the set of codepoints, a second indicator identifying whether the first TCJ state is associated with the first subset of the set of TC states or the second subset of the set of TC states; and transmitting, in the first codepoint of the set of codepoints, a third indicator identifying whether the second TCJ state is associated with the first subset of the set of TC states or the second subset of the set of TC states.

Aspect 36: The method of any of aspects 13 through 15, where the first interface is further configured to: output, in the MAC-CE, a first bitmap associated with the first subset of the set of TC states; and transmitting, in the MAC-CE, a second bitmap associated with the second subset of the set of TC states.

Aspect 37: The method of aspect 16, where the first interface is further configured to: output a first codepoint of the set of codepoints, the first codepoint corresponding to a bit of the first bitmap and a bit of the second bitmap, and the first codepoint including an indication of a first TCI state of the first subset of the set of TCI states and a second TCI state of the second subset of the set of TCI states.

Aspect 38: The method of any of aspects 16 through 17, where the first interface is further configured to: output a first codepoint of the set of codepoints, the first codepoint corresponding to a single bit from one of the first bitmap or the second bitmap, and the first codepoint including an indication of a single TCI state of a respective one of the first subset of the set of TCI states or the second subset of the set of TCI states.

Aspect 39: The method of any of aspects 11 through 18, where the downlink control information message includes the grant of resources for communicating with a single transmission reception point, the single transmission reception point including the first transmission reception point.

Aspect 40: The method of any of aspects 11 through 19, where the downlink control information message includes the grant of resources for communicating with multiple transmission reception points, the multiple transmission reception points including the first transmission reception point and a second transmission reception point.

Aspect 41: An apparatus for wireless communications at a UE, including at least one means for: receiving, from a network entity, control signaling identifying a set of TCI states, each TCI state of the set of TCI states associated with a TCI state type; receiving, from the network entity, a MAC CE message including a set of codepoints, each codepoint of the set of codepoints activating one or more TCI states of the set of TCI states and indicating the TCI state type for the one or more TCI states; receiving, from the network entity, a DCI message including a grant of resources for communicating with at least a first transmission reception point (TRP) associated with the network entity and an indication of at least one TCI state of the one or more TCI states; and communicating with the at least the first TRP according to the at least one TCI state.

Aspect 42: The apparatus of aspect 1, where the means for receiving the MAC-CE includes means for: receiving the set of codepoints in the MAC-CE, each codepoint including a first bit indicating whether the codepoint indicates a single TCI state or a pair of TCI states.

Aspect 43: The apparatus of any of aspects 1 through 2, where the means for receiving the control signaling identifying the set of TCI states includes means for: receiving the control signaling including an indication of a first subset of the set of TCI states associated with the TCI state type including uplink, and an indication of a second subset of the set of TCI states associated with the TCI state type including downlink.

Aspect 44: The apparatus of aspect 3, where the means for receiving the MAC-CE includes means for: receiving, in a first codepoint of the set of codepoints, a first indicator that the codepoint identifies a single TCI state; and receiving, in the first codepoint of the set of codepoints based at least in part on receiving the first bit of each codepoint, a second indicator identifying whether the single TCI state is associated with the first subset of the set of TCI states or the second subset of the set of TCI states.

Aspect 45: The apparatus of any of aspects 3 through 4, where the means for receiving the MAC-CE includes means for: receiving, in a first codepoint of the set of codepoints, a first indicator that the first codepoint identifies a first TCI state and a second TCI state; receiving, in the first codepoint of the set of codepoints, a second indicator identifying whether the first TCI state is associated with the first subset of the set of TCI states or the second subset of the set of TCI states; and receiving, in the first codepoint of the set of codepoints, a third indicator identifying whether the second TCI state is associated with the first subset of the set of TCI states or the second subset of the set of TCI states.

Aspect 46: The apparatus of any of aspects 3 through 5, where the means for receiving the MAC-CE includes means for: receiving, in the MAC-CE, a first bitmap associated with the first subset of the set of TCI states; and receiving, in the MAC-CE, a second bitmap associated with the second subset of the set of TCI states.

Aspect 47: The apparatus of aspect 6, further including means for: receiving a first codepoint of the set of codepoints, the first codepoint corresponding to a bit of the first bitmap and a bit of the second bitmap, and the first codepoint including an indication of a first TCI state of the first subset of the set of TCI states and a second TCI state of the second subset of the set of TCI states.

Aspect 48: The apparatus of any of aspects 6 through 7, further including means for: receiving a first codepoint of the set of codepoints, the first codepoint corresponding to a single bit from one of the first bitmap or the second bitmap, and the first codepoint including an indication of a single TCI state of a respective one of the first subset of the set of TCI states or the second subset of the set of TCI states.

Aspect 49: The apparatus of any of aspects 1 through 8, where the downlink control information message includes the grant of resources for communicating with a single transmission reception point, the single transmission reception point including the first transmission reception point.

Aspect 50: The apparatus of any of aspects 1 through 9, where the downlink control information message includes the grant of resources for communicating with multiple transmission reception points, the multiple transmission reception points including the first transmission reception point and a second transmission reception point.

Aspect 51: A apparatus for wireless communications, including: transmitting, to a UE, control signaling identifying a set of TCI states, each TCI state of the set of TCI states associated with a TCI state type, the TCI state type; transmitting, to the UE, a MAC CE message including a set of codepoints, each codepoint of the set of codepoints activating one or more TCI states of the set of TCI states and indicating the TCI state type for the one or more TCI states; and transmitting, to the UE, a downlink control information message including a grant of resources for communicating with at least a first transmission reception point associated with the network entity and an indication of at least one TCI state of the one or more TCI states.

Aspect 52: The apparatus of aspect 11, where transmitting the MAC-CE includes: transmitting the set of codepoints in the MAC-CE, each codepoint including a first indicator that identifies whether the codepoint indicates a single TCI state or a pair of TCI states.

Aspect 53: The apparatus of any of aspects 11 through 12, where transmitting the control signaling identifying the set of TCI states includes: transmitting the control signaling including an indication of a first subset of the set of TCI states associated with the TCI state type including uplink, and an indication of a second subset of the set of TCI states associated with the TCI state type including downlink.

Aspect 54: The apparatus of aspect 13, where transmitting the MAC-CE includes: transmitting, in a first codepoint of the set of codepoints, a first bit indicator identifying that the codepoint indicates a single TCI state; and transmitting, in the first codepoint of the set of codepoints based at least in part on transmitting the first bit of each codepoint, a second indicator identifying whether the single TCI state is associated with the first subset of the set of TCI states or the second subset of the set of TCI states.

Aspect 55: The apparatus of any of aspects 13 through 14, where transmitting the MAC-CE includes: transmitting, in a first codepoint of the set of codepoints, a first bit indicator that the first codepoint identifies a first TCI state and a second TCI state; transmitting, in the first codepoint of the set of codepoints, a second indicator identifying whether the first TCI state is associated with the first subset of the set of TCI states or the second subset of the set of TCI states; and transmitting, in the first codepoint of the set of codepoints, a third indicator identifying whether the second TCI state is associated with the first subset of the set of TCI states or the second subset of the set of TCI states.

Aspect 56: The apparatus of any of aspects 13 through 15, where transmitting the MAC-CE includes: transmitting, in the MAC-CE, a first bitmap associated with the first subset of the set of TCI states; and transmitting, in the MAC-CE, a second bitmap associated with the second subset of the set of TCI states.

Aspect 57: The apparatus of aspect 16, further including: transmitting a first codepoint of the set of codepoints, the first codepoint corresponding to a bit of the first bitmap and a bit of the second bitmap, and the first codepoint including an indication of a first TCI state of the first subset of the set of TCI states and a second TCI state of the second subset of the set of TCI states.

Aspect 58: The apparatus of any of aspects 16 through 17, further including: transmitting a first codepoint of the set of codepoints, the first codepoint corresponding to a single bit from one of the first bitmap or the second bitmap, and the first codepoint including an indication of a single TCI state of a respective one of the first subset of the set of TCI states or the second subset of the set of TCI states.

Aspect 59: The apparatus of any of aspects 11 through 18, where the downlink control information message includes the grant of resources for communicating with a single transmission reception point, the single transmission reception point including the first transmission reception point.

Aspect 60: The apparatus of any of aspects 11 through 19, where the downlink control information message includes the grant of resources for communicating with multiple transmission reception points, the multiple transmission reception points including the first transmission reception point and a second transmission reception point.

Aspect 61: A method for wireless communications at a UE, including: receiving, from a network entity, control signaling identifying a set of TCI states, each TCI state of the set of TCI states associated with a TCI state type; receiving, from the network entity, a MAC CE message including a set of codepoints, each codepoint of the set of codepoints activating one or more TCI states of the set of TCI states and indicating the TCI state type for the one or more TCI states; receiving, from the network entity, a DCI message including a grant of resources for communicating with at least a first TRP associated with the network entity and an indication of at least one TCI state of the one or more TCI states; and communicating with the at least the first TRP according to the at least one TCI state.

Aspect 62: The method of aspect 1, where receiving the MAC-CE includes: receiving the set of codepoints in the MAC-CE, each codepoint including a first bit indicating whether the codepoint indicates a single TCI state or a pair of TCI states.

Aspect 63: The method of any of aspects 1 through 2, where receiving the control signaling identifying the set of TCI states includes: receiving the control signaling including an indication of a first subset of the set of TCI states associated with the TCI state type including uplink, and an indication of a second subset of the set of TCI states associated with the TCI state type including downlink.

Aspect 64: The method of aspect 3, where receiving the MAC-CE includes: receiving, in a first codepoint of the set of codepoints, a first indicator that the codepoint identifies a single TCI state; and receiving, in the first codepoint of the set of codepoints based at least in part on receiving the first bit of each codepoint, a second indicator identifying whether the single TCI state is associated with the first subset of the set of TCI states or the second subset of the set of TCI states.

Aspect 65: The method of any of aspects 3 through 4, where receiving the MAC-CE includes: receiving, in a first codepoint of the set of codepoints, a first indicator that the first codepoint identifies a first TCI state and a second TCI state; receiving, in the first codepoint of the set of codepoints, a second indicator identifying whether the first TCI state is associated with the first subset of the set of TCI states or the second subset of the set of TCI states; and receiving, in the first codepoint of the set of codepoints, a third indicator identifying whether the second TCI state is associated with the first subset of the set of TCI states or the second subset of the set of TCI states.

Aspect 66: The method of any of aspects 3 through 5, where receiving the MAC-CE includes: receiving, in the MAC-CE, a first bitmap associated with the first subset of the set of TCI states; and receiving, in the MAC-CE, a second bitmap associated with the second subset of the set of TCI states.

Aspect 67: The method of aspect 6, further including: receiving a first codepoint of the set of codepoints, the first codepoint corresponding to a bit of the first bitmap and a bit of the second bitmap, and the first codepoint including an indication of a first TCI state of the first subset of the set of TCI states and a second TCI state of the second subset of the set of TCI states.

Aspect 68: The method of any of aspects 6 through 7, further including: receiving a first codepoint of the set of codepoints, the first codepoint corresponding to a single bit from one of the first bitmap or the second bitmap, and the first codepoint including an indication of a single TCI state of a respective one of the first subset of the set of TCI states or the second subset of the set of TCI states.

Aspect 69: The method of any of aspects 1 through 8, where the downlink control information message includes the grant of resources for communicating with a single transmission reception point, the single transmission reception point including the first transmission reception point.

Aspect 70: The method of any of aspects 1 through 9, where the downlink control information message includes the grant of resources for communicating with multiple transmission reception points, the multiple transmission reception points including the first transmission reception point and a second transmission reception point.

Aspect 71: A method for wireless communications, including: transmitting, to a UE, control signaling identifying a set of TC states, each TCJ state of the set of TCJ states associated with a TCJ state type, the TCJ state type; transmitting, to the UE, a MAC CE message including a set of codepoints, each codepoint of the set of codepoints activating one or more TCJ states of the set of TC states and indicating the TCJ state type for the one or more TCJ states; and transmitting, to the UE, a downlink control information message including a grant of resources for communicating with at least a first transmission reception point associated with the network entity and an indication of at least one TCJ state of the one or more TCJ states.

Aspect 72: The method of aspect 11, where transmitting the MAC-CE includes: transmitting the set of codepoints in the MAC-CE, each codepoint including a first indicator that identifies whether the codepoint indicates a single TCJ state or a pair of TC states.

Aspect 73: The method of any of aspects 11 through 12, where transmitting the control signaling identifying the set of TC states includes: transmitting the control signaling including an indication of a first subset of the set of TC states associated with the TCJ state type including uplink, and an indication of a second subset of the set of TCJ states associated with the TCJ state type including downlink.

Aspect 74: The method of aspect 13, where transmitting the MAC-CE includes: transmitting, in a first codepoint of the set of codepoints, a first bit indicator identifying that the codepoint indicates a single TCJ state; and transmitting, in the first codepoint of the set of codepoints based at least in part on transmitting the first bit of each codepoint, a second indicator identifying whether the single TCI state is associated with the first subset of the set of TCI states or the second subset of the set of TCI states.

Aspect 75: The method of any of aspects 13 through 14, where transmitting the MAC-CE includes: transmitting, in a first codepoint of the set of codepoints, a first bit indicator that the first codepoint identifies a first TCI state and a second TCI state; transmitting, in the first codepoint of the set of codepoints, a second indicator identifying whether the first TCI state is associated with the first subset of the set of TCI states or the second subset of the set of TCI states; and transmitting, in the first codepoint of the set of codepoints, a third indicator identifying whether the second TCI state is associated with the first subset of the set of TCI states or the second subset of the set of TCI states.

Aspect 76: The method of any of aspects 13 through 15, where transmitting the MAC-CE includes: transmitting, in the MAC-CE, a first bitmap associated with the first subset of the set of TCI states; and transmitting, in the MAC-CE, a second bitmap associated with the second subset of the set of TCI states.

Aspect 77: The method of aspect 16, further including: transmitting a first codepoint of the set of codepoints, the first codepoint corresponding to a bit of the first bitmap and a bit of the second bitmap, and the first codepoint including an indication of a first TCI state of the first subset of the set of TCI states and a second TCI state of the second subset of the set of TCI states.

Aspect 78: The method of any of aspects 16 through 17, further including: transmitting a first codepoint of the set of codepoints, the first codepoint corresponding to a single bit from one of the first bitmap or the second bitmap, and the first codepoint including an indication of a single TCI state of a respective one of the first subset of the set of TCI states or the second subset of the set of TCI states.

Aspect 79: The method of any of aspects 11 through 18, where the downlink control information message includes the grant of resources for communicating with a single transmission reception point, the single transmission reception point including the first transmission reception point.

Aspect 80: The method of any of aspects 11 through 19, where the downlink control information message includes the grant of resources for communicating with multiple transmission reception points, the multiple transmission reception points including the first transmission reception point and a second transmission reception point.

As used herein, the term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the Figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this may not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above may not be understood as requiring such separation in all implementations, and it may be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. An apparatus for wireless communications at a user equipment (UE), comprising:
a first interface configured to:
obtain, from a network entity, control signaling identifying a set of transmission configuration indicator (TCI) states, each TCI state of the set of TCI states associated with a TCI state type;
obtain, from the network entity, a media access control (MAC) control element (CE) message comprising a set of codepoints, each codepoint of the set of codepoints activating one or more TCI states of the set of TCI states and indicating the TCI state type for the one or more TCI states;
obtain, from the network entity, a downlink control information (DCI) message comprising a grant of resources for communicating with at least a first transmission reception point (TRP) associated with the network entity and an indication of at least one TCI state of the one or more TCI states; and
the first interface or a second interface configured to:
output at least one message to the at least the first TRP according to the at least one TCI state.

2. The apparatus of claim 1, wherein the first interface is further configured to:
obtain the set of codepoints in the MAC-CE, each codepoint comprising a first bit indicating whether the codepoint indicates a single TCI state or a pair of TCI states.

3. The apparatus of claim 1, wherein the first interface is further configured to:
obtain the control signaling comprising an indication of a first subset of the set of TCI states associated with the TCI state type comprising uplink, and an indication of a second subset of the set of TCI states associated with the TCI state type comprising downlink.

4. The apparatus of claim 3, wherein the first interface is further configured to:
obtain, in a first codepoint of the set of codepoints, a first indicator that the codepoint identifies a single TCI state; and
obtain, in the first codepoint of the set of codepoints based at least in part on receiving the first bit of each codepoint, a second indicator identifying whether the single TCI state is associated with the first subset of the set of TCI states or the second subset of the set of TCI states.

5. The apparatus of claim 3, wherein the first interface is further configured to:
obtain, in a first codepoint of the set of codepoints, a first indicator that the first codepoint identifies a first TCI state and a second TCI state;
obtain, in the first codepoint of the set of codepoints, a second indicator identifying whether the first TCI state is associated with the first subset of the set of TCI states or the second subset of the set of TCI states; and
obtain, in the first codepoint of the set of codepoints, a third indicator identifying whether the second TCI state is associated with the first subset of the set of TCI states or the second subset of the set of TCI states.

6. The apparatus of claim 3, wherein first interface is configured to:
obtain, in the MAC-CE, a first bitmap associated with the first subset of the set of TCI states; and
obtain, in the MAC-CE, a second bitmap associated with the second subset of the set of TCI states.

7. The apparatus of claim 6, wherein the first interface is configured to:
obtain a first codepoint of the set of codepoints, the first codepoint corresponding to a bit of the first bitmap and a bit of the second bitmap, and the first codepoint comprising an indication of a first TCI state of the first subset of the set of TCI states and a second TCI state of the second subset of the set of TCI states.

8. The apparatus of claim 6, wherein the first interface is configured to:
obtain a first codepoint of the set of codepoints, the first codepoint corresponding to a single bit from one of the first bitmap or the second bitmap, and the first codepoint comprising an indication of a single TCI state of a respective one of the first subset of the set of TCI states or the second subset of the set of TCI states.

9. The apparatus of claim 1, wherein the DCI message comprises the grant of resources for communicating with a single transmission reception point, the single transmission reception point comprising the first transmission reception point.

10. The apparatus of claim 1, wherein the DCI message comprises the grant of resources for communicating with multiple transmission reception points, the multiple transmission reception points comprising the first transmission reception point and a second transmission reception point.

11. An apparatus for wireless communications, comprising:
a first interface configured to:
output, to a user equipment (UE), control signaling identifying a set of transmission configuration indicator (TCI) states, each TCI state of the set of TCI states associated with a TCI state type, the TCI state type;
output, to the UE, a media access control (MAC) control element (CE) message comprising a set of codepoints, each codepoint of the set of codepoints activating one or more TCI states of the set of TCI states and indicating the TCI state type for the one or more TCI states; and
output, to the UE, a DCI message comprising a grant of resources for communicating with at least a first transmission reception point associated with the network entity and an indication of at least one TCI state of the one or more TCI states.

12. The apparatus of claim 11, wherein the first interface is further configured to:
output the set of codepoints in the MAC-CE, each codepoint comprising a first indicator that identifies whether the codepoint indicates a single TCI state or a pair of TCI states.

13. The apparatus of claim 11, wherein the first interface is further configured to:
output the control signaling comprising an indication of a first subset of the set of TCI states associated with the TCI state type comprising uplink, and an indication of a second subset of the set of TCI states associated with the TCI state type comprising downlink.

14. The apparatus of claim 13, wherein the first interface is further configured to:
output, in a first codepoint of the set of codepoints, a first bit indicator identifying that the codepoint indicates a single TCI state; and
transmit, in the first codepoint of the set of codepoints based at least in part on transmitting the first bit of each codepoint, a second indicator identifying whether the single TCI state is associated with the first subset of the set of TCI states or the second subset of the set of TCI states.

15. The apparatus of claim 13, wherein the first interface is further configured to:
output, in a first codepoint of the set of codepoints, a first bit indicator that the first codepoint identifies a first TCI state and a second TCI state;
output, in the first codepoint of the set of codepoints, a second indicator identifying whether the first TCI state is associated with the first subset of the set of TCI states or the second subset of the set of TCI states; and
output, in the first codepoint of the set of codepoints, a third indicator identifying whether the second TCI state is associated with the first subset of the set of TCI states or the second subset of the set of TCI states.

16. The apparatus of claim 13, wherein first interface is further configured to:
output, in the MAC-CE, a first bitmap associated with the first subset of the set of TCI states; and
output, in the MAC-CE, a second bitmap associated with the second subset of the set of TCI states.

17. The apparatus of claim 16, wherein the first interface is further configured to:
output a first codepoint of the set of codepoints, the first codepoint corresponding to a bit of the first bitmap and a bit of the second bitmap, and the first codepoint comprising an indication of a first TCI state of the first subset of the set of TCI states and a second TCI state of the second subset of the set of TCI states.

18. The apparatus of claim 16, wherein the first interface is further configured to:
output a first codepoint of the set of codepoints, the first codepoint corresponding to a single bit from one of the first bitmap or the second bitmap, and the first codepoint comprising an indication of a single TCI state of a respective one of the first subset of the set of TCI states or the second subset of the set of TCI states.

19. The apparatus of claim 11, wherein the DCI message comprises the grant of resources for communicating with a single transmission reception point, the single transmission reception point comprising the first transmission reception point.

20. The apparatus of claim 11, wherein the DCI message comprises the grant of resources for communicating with multiple transmission reception points, the multiple transmission reception points comprising the first transmission reception point and a second transmission reception point.

21. A method for wireless communications at a user equipment (UE), comprising:
receiving, from a network entity, control signaling identifying a set of transmission configuration indicator (TCI) states, each TCI state of the set of TCI states associated with a TCI state type;
receiving, from the network entity, a media access control (MAC) control element (CE) message comprising a set of codepoints, each codepoint of the set of codepoints activating one or more TCI states of the set of TCI states and indicating the TCI state type for the one or more TCI states;
receiving, from the network entity, a downlink control information (DCI) message comprising a grant of resources for communicating with at least a first transmission reception point (TRP) associated with the network entity and an indication of at least one TCI state of the one or more TCI states; and
communicating with the at least the first TRP according to the at least one TCI state.

22. The method of claim 21, wherein receiving the MAC-CE comprises:
receiving the set of codepoints in the MAC-CE, each codepoint comprising a first bit indicating whether the codepoint indicates a single TCI state or a pair of TCI states.

23. The method of claim 21, wherein receiving the control signaling identifying the set of TCI states comprises:
receiving the control signaling comprising an indication of a first subset of the set of TCI states associated with the TCI state type comprising uplink, and an indication of a second subset of the set of TCI states associated with the TCI state type comprising downlink.

24. The method of claim 23, wherein receiving the MAC-CE comprises:
receiving, in the MAC-CE, a first bitmap associated with the first subset of the set of TCI states; and
receiving, in the MAC-CE, a second bitmap associated with the second subset of the set of TCI states.

25. The method of claim 24, further comprising:
receiving a first codepoint of the set of codepoints, the first codepoint corresponding to a bit of the first bitmap and a bit of the second bitmap, and the first codepoint comprising an indication of a first TCI state of the first subset of the set of TCI states and a second TCI state of the second subset of the set of TCI states.

26. The method of claim 24, further comprising:
receiving a first codepoint of the set of codepoints, the first codepoint corresponding to a single bit from one of the first bitmap or the second bitmap, and the first codepoint comprising an indication of a single TCI state of a respective one of the first subset of the set of TCI states or the second subset of the set of TCI states.

27. A method for wireless communications, comprising:
transmitting, to a user equipment (UE), control signaling identifying a set of transmission configuration indicator (TCI) states, each TCI state of the set of TCI states associated with a TCI state type, the TCI state type;
transmitting, to the UE, a media access control (MAC) control element (CE) message comprising a set of codepoints, each codepoint of the set of codepoints activating one or more TCI states of the set of TCI states and indicating the TCI state type for the one or more TCI states; and
transmitting, to the UE, a downlink control information (DCI) message comprising a grant of resources for communicating with at least a first transmission reception point associated with the network entity and an indication of at least one TCI state of the one or more TCI states.

28. The method of claim 27, wherein transmitting the MAC-CE comprises:
transmitting the set of codepoints in the MAC-CE, each codepoint comprising a first indicator that identifies whether the codepoint indicates a single TCI state or a pair of TCI states.

29. The method of claim 27, wherein transmitting the control signaling identifying the set of TCI states comprises:
transmitting the control signaling comprising an indication of a first subset of the set of TCI states associated with the TCI state type comprising uplink, and an indication of a second subset of the set of TCI states associated with the TCI state type comprising downlink.

30. The method of claim 29, wherein transmitting the MAC-CE comprises:
transmitting, in the MAC-CE, a first bitmap associated with the first subset of the set of TCI states; and
transmitting, in the MAC-CE, a second bitmap associated with the second subset of the set of TCI states.
